(19) United States
(12) Patent Application Publication
(10) Pub. No.: US 2009/0176945 A1
(43) Pub. Date: Jul. 9, 2009

(54) SULFUR-CONTAINING POLYURETHANE

(75) Inventors: Nina Bojkova, Monroeville, PA (US); Daryl J. Robinson, Monroeville, PA (US); Thomas G. Rukavina, New Kensington, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/405,720

(22) Filed: Mar. 17, 2009

Related U.S. Application Data
(62) Division of application No. 11/303,671, filed on Dec. 16, 2005.

(51) Int. Cl. C08G 18/87

(52) U.S. Cl. 525/453; 525/452

(57) ABSTRACT

Sulfur-containing polyurethane comprising the reaction product of:
(a) material chosen from polyisocyanate, polyisothiocyanate or mixtures thereof;
(b) material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, and mixtures thereof; and
(c) material chosen from diol having molecular weight of less than or equal to 200 grams/mole, dithiol having molecular weight of less than or equal to 600 grams/mole, difunctional material containing both hydroxyl and SH groups having molecular weight of less than or equal to 600 grams/mole, and mixtures thereof, wherein at least one of (a), (b) or (c) is sulfur-containing.

### CROSS REFERENCE TO RELATED APPLICATIONS

This application is a division of U.S. patent application Ser. No. 11/303,671 filed Dec. 16, 2005.

The present invention relates to polyurethanes and sulfur-containing polyurethanes and methods for their preparation.

A number of organic polymeric materials, such as plastics, have been developed as alternatives and replacements for glass in applications such as optical lenses, fiber optics, windows and automotive, nautical and aviation transparencies. These polymeric materials can provide advantages relative to glass, including, shatter resistance, lighter weight for a given application, ease of molding and ease of dying. However, the refractive indices of many polymeric materials are generally lower than that of glass. In ophthalmic applications, the use of a polymeric material having a lower refractive index will require a thicker lens relative to a material having a higher refractive index. A thicker lens is not desirable.

Thus, there is a need in the art to develop a polymeric material having at least one of the following properties: an adequate refractive index, light weight/low density, good impact resistance/strength, good optical clarity, good rigidity/hardness, good thermal properties, and ease in processing of optical lenses made from said material.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In a non-limiting embodiment, polyurethane of the present invention can be the reaction product of polyisocyanate; trifunctional or higher-functional polyol having a molecular weight of less than or equal to 200 grams/mole; and diol having a molecular weight of less than or equal to 200 grams/mole.

In another non-limiting embodiment, sulfur-containing polyurethane of the present invention can be prepared by combining

(a) material chosen from polyisocyanate, polyisothiocyanate, and mixtures thereof; and

(b) material chosen from trifunctional or higher-functional polyol, trifunctional or higher-functional polythiol, trifunctional or higher-functional material containing both hydroxyl and SH groups, and mixtures thereof; and

(c) material chosen from diol, dithiol, difunctional material containing both hydroxyl and SH groups, and mixtures thereof;

wherein at least one of (a), (b), and (c) is sulfur-containing. In a further non-limiting embodiment, said dithiol of (c) can include at least one dithiol oligomer.

As used herein and in the claims, the terms “isocyanate” and “isothiocyanate” include unblocked compounds capable of forming a covalent bond with a reactive group such as thiol, hydroxyl, or amine functional group. In alternate non-limiting embodiments, the polyisocyanate of the present invention can contain at least two functional groups chosen from isocyanate (NCO), the polyisothiocyanate can contain at least two functional groups chosen from isothiocyanate (NCS), and the isocyanate and isothiocyanate materials can each include combinations of isocyanate and isothiocyanate functional groups. In a non-limiting embodiment, polyisothiocyanate can contain at least two groups chosen from isothiocyanate or combination of isothiocyanate and isocyanate.

In alternate non-limiting embodiments, the polyurethane and/or sulfur-containing polyurethane of the invention when polymerized can produce a polymerizate having a refractive index of at least 1.50, or at least 1.53, or at least 1.55, or at least 1.60. In further non-limiting embodiments, wherein the polyurethane and/or sulfur-containing polyurethane of the present invention includes materials containing at least one aromatic ring and/or at least one sulfur-containing moiety, or combinations or mixtures thereof, the polyurethane and/or sulfur-containing polyurethane when polymerized can produce a polymerizate having a refractive index of at least 1.53, or at least 1.55, or at least 1.56, or at least 1.57, or at least 1.58, or at least 1.59, or at least 1.60, or at least 1.62, or at least 1.65. In further alternate non-limiting embodiments, the polyurethane and sulfur-containing polyurethane of the invention when polymerized can produce a polymerizate having an Abbe number of at least 30, or at least 32, or at least 35, or at least 38, or at least 39, or at least 40, or at least 44. The refractive index and Abbe number can be determined by methods known in the art such as American Standard Test Method (ASTM) Number D 542-00. Further, the refractive index and Abbe number can be determined using various known instruments. In a non-limiting embodiment of the present invention, the refractive index and Abbe number can be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8.1. Further, in a non-limiting embodiment, an Atago, model DR-M2 Multi-Wavelength Digital Abbe Refractometer can be used to measure the refractive index and Abbe number of the samples/specimens.

Good or adequately high rigidity/hardness and/or thermal properties are desirable characteristics for a polymerizate in order for it to be useful for optical/ophthalmic lens applications because high rigidity/hardness and/or thermal properties may be related to at least one of improved accuracy, processing yields, and durability when said polymerizate is subjected to processes related to manufacture of ophthalmic lens article, such as but not limited to surfacing, edging, and coating processes.

In a non-limiting embodiment, the polyurethane and/or sulfur-containing polyurethane when polymerized can produce a polymerizate with adequately high hardness. Hardness can be determined by methods known in the art. In a non-limiting embodiment, hardness can be measured in accordance with ISO standard test method BS EN ISO 14577-1:2002. Further, in a non-limiting embodiment, a Fischer Scope H-100 instrument, supplied by Fischer Technology, Inc., can be used to measure the Martens Hardness, in accordance with BS EN ISO 14577-1:2002, and said Martens Hardness can be reported in the units of Newtons(N)/mm².

In alternate non-limiting embodiments, the polyurethane or sulfur-containing polyurethane of the present invention when polymerized can produce a polymerizate having Martens Hardness (HM 0.3/15/0) of greater than or equal to 80, or greater than 100, or greater than 110, or greater than 120, or greater than 130 Newton/mm²; or less than 250, or less than 200 Newton/mm².

In a non-limiting embodiment, the polyurethane and/or sulfur-containing polyurethane when polymerized can produce a polymerizate with adequately high thermal properties. Thermal properties can be determined by methods known in the art. In a non-limiting embodiment, thermal properties can be measured in accordance with ASTM D648 Method B. Further, in a non-limiting embodiment, thermal properties of a polymerizate can be reported as Heat Distortion Temperature (i.e., temperature at which 0.254 mm (10 mils) deflection of sample bar occurs) and Total Deflection Temperature (i.e., temperature at which 2.54 mm (100 mils) deflection occurs), under the conditions of this test method. In a further non-limiting embodiment, the test can be carried out using an HDT Vicat instrument, supplied by CEAST USA, Inc.

In alternate non-limiting embodiments, the polyurethane or sulfur-containing polyurethane of the present invention when polymerized can produce a polymerizate having Heat Distortion Temperature of at least 80° C., or at least 90° C., or at least 100° C. or at least 110° C.

In a non-limiting embodiment, the polyurethane and/or sulfur-containing polyurethane when polymerized can produce a polymerizate having adequately good impact resistance/strength. Impact resistance can be measured using a variety of conventional methods known to one skilled in the art.

In a non-limiting embodiment, the impact resistance can be measured using the Impact Energy Test, in which steel balls of increasing weight are successively dropped from a height of 1.27 meters onto a flat sheet sample of the polymerizate with a thickness of 3 mm, and which is supported on a neoprene O-ring, with inner diameter of 25 mm and thickness of 2.3 mm, affixed to a cylindrical steel holder. The sheet is determined to have passed the test if the sheet does not fracture. The sheet is determined to have failed the test when the sheet fractures. As used herein, the term “fracture” refers to a crack through the entire thickness of the sheet into two or more separate pieces, or detachment of one or more pieces of material from the backside of the sheet (i.e., the side of the sheet opposite the side of impact). The impact strength of the sample is reported as the impact energy (joules) that corresponds to the highest level (i.e., largest ball) that the flat sheet passes, as is described in greater detail in the Experimental section herein.

In an alternate non-limiting embodiment, using the Impact Energy Test as described herein, the polyurethane or sulfur-containing polyurethane of the present invention when polymerized can produce a polymerizate with impact strength of at least 1.0 Joule, or at least 2.0 Joules, or at least 4.95 Joules.

In a non-limiting embodiment, polyurethane of the present invention can comprise the reaction product of polyisocyanate; trifunctional or higher-functional polyol; and diol. In a non-limiting embodiment, the ratio of the number of equivalents of said trifunctional or higher-functional polyol to the number of equivalents of said polyisocyanate can be from 0.05:1.0 to 0.4 to 1.0.

In a non-limiting embodiment, polyurethane of the present invention can comprise the reaction product of polyisocyanate; trifunctional or higher-functional polyol having molecular weight of less than or equal to 200 grams/mole; and diol having molecular weight of less than or equal to 200 grams/mole. In a non-limiting embodiment, said trifunctional or higher functional polyol can be trifunctional and/or tetrafunctional polyol. In another non-limiting embodiment, the ratio of the number of equivalents of said trifunctional or higher-functional polyol to the number of equivalents of said polyisocyanate can be from 0.05:1.0 to 0.4 to 1.0. In further non-limiting embodiments, said ratio can be from 0.1:1.0 to 0.4:1.0, or from 0.15:1.0 to 0.4:1.0, or from 0.2:1.0 to 0.4 to 1.0, or from 0.1:1.0 to 0.3:1.0, or from 0.15:1.0 to 0.3:1.0, or from 0.2:1.0 to 0.3:1.0.

In another non-limiting embodiment, sulfur-containing polyurethane of the present invention can comprise the reaction product of

(a) material chosen from polyisocyanate, or polyisothiocyanate, and mixtures thereof;

(b) material chosen from trifunctional or higher-functional polyol, or trifunctional or higher-functional polythiol, or trifunctional or higher-functional material containing both hydroxyl and SH groups, and mixtures thereof; and

(c) material chosen from diol, dithiol, difunctional material containing both hydroxyl and SH groups, and mixtures thereof;

wherein at least one of (a), (b), and c) is sulfur-containing. In a non-limiting embodiment, said dithiol of (c) can include at least one dithiol oligomer, with the proviso said dithiol oligomer constitutes less than or equal to 70 mole percent of species included in (c). In an alternate non-limiting embodiment, the ratio of the sum of the number of equivalents of said trifunctional or higher-functional polyol plus said trifunctional or higher-functional polythiol plus said trifunctional or higher-functional material containing both hydroxyl and SH groups to the sum of the number of equivalents of said polyisocyanate plus said polyisothiocyanate can be from 0.05:1.0 to 0.4 to 1.0.

In a non-limiting embodiment, sulfur-containing polyurethane of the present invention can comprise the reaction product of:

(a) material chosen from polyisocyanate, or polyisothiocyanate, and mixtures thereof;

(b) material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, or, and mixtures thereof; and

(c) material chosen from diol having molecular weight of less than or equal to 200 grams/mole, dithiol having molecular weight of less than or equal to 600 grams/mole, difunctional material containing both hydroxyl and SH groups having molecular weight of less than or equal to 600 grams/mole, and mixtures thereof; wherein at least one of (a), (b), and (c) is sulfur-containing.

In a non-limiting embodiment, said dithiol of (c) can include dithiol oligomer having number average molecular weight of less than or equal to 600 grams/mole, with the proviso that the dithiol oligomer constitutes less than or equal to 70 mole percent of species included in (c). In a further non-limiting embodiment, (b) can be trifunctional and/or tetrafunctional polyol, trifunctional and/or tetrafunctional polythiol, trifunctional and/or tetrafunctional material containing both hydroxyl and SH groups, or mixtures thereof. In an alternate non-limiting embodiment, the ratio of the sum of the number of equivalents of the trifunctional or higher-functional polyol and the trifunctional or higher-functional polythiol and the trifunctional or higher-functional material containing both hydroxyl and SH groups to the sum of the number of equivalents of the polyisocyanate and the polyisothiocyanate can be from 0.05:1.0 to 0.4 to 1.0. In further non-limiting embodiments, said ratio can be from 0.1:1.0 to 0.4:1.0, or from 0.15:1.0 to 0.4:1.0, or from 0.2:1.0 to 0.4:1.0, or from 0.1:1.0 to 0.3:1.0, or from 0.15:1.0 to 0.3:1.0, or from 0.2:1.0 to 0.3:1.0.

In a non-limiting embodiment, the polyurethane of the present invention can be prepared by (a) reacting polyisocyanate with trifunctional or higher-functional polyol having molecular weight of less than or equal to 200 grams/mole to form isocyanate terminated polyurethane prepolymer; and (b) chain-extending the prepolymer with active hydrogen-containing material, wherein the active hydrogen-containing material can include diol having molecular weight of less than or equal to 200 grams/mole. In this non-limiting embodiment, the active hydrogen-containing material can optionally further include trifunctional or higher-functional polyol, having molecular weight of less than or equal to 200 grams/mole. In an alternate non-limiting embodiment, the amount of active hydrogen-containing material included in (b) and the amount of polyurethane prepolymer can be selected such that the equivalent ratio of (OH):(NCO) can be from 1.1:1.0 to 0.85:1.0. In alternate non-limiting embodiments, the equivalent ratio of (OH):(NCO) can range from 1.1:1.0 to 0.90:1.0, or from 1.1:1.0 to 0.95:1.0, or from 1.0:1.0 to 0.90:1.0, or from 1.0:1.0 to 0.95:1.0.

In a non-limiting embodiment, the sulfur-containing polyurethane of the present invention can be prepared by (a) reacting material chosen from polyisocyanate, polyisothiocyanate, and mixtures thereof with material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, and mixtures thereof, to form isocyanate or isothiocyanate or isothiocyanate/isocyanate terminated polyurethane prepolymer or sulfur-containing polyurethane prepolymer; and (b) chain-extending the prepolymer with active hydrogen-containing material, wherein the active hydrogen containing material can include material selected from diol having a molecular weight of less than or equal to 200 grams/mole, dithiol having a molecular weight of less than or equal to 600 grams/mole, or difunctional material containing both hydroxyl and SH groups having a molecular weight of less than or equal to 600 grams/mole, and mixtures thereof; wherein at least one of the materials included in (a) and (b) is sulfur-containing. In a non-limiting embodiment, the dithiol of (b) can include dithiol oligomer having number average molecular weight of less than or equal to 600 grams/mole, with the proviso that the dithiol oligomer constitutes less than or equal to 70 mole percent of the species included in (b). In another non-limiting embodiment, the active hydrogen-containing material of (b) can further include trifunctional or higher-functional polyol having a molecular weight of less than or equal to 200 grams/mole, trifunctional or higher-functional polythiol having a molecular weight of less than or equal to 700 grams/mole, trifunctional or higher-functional material containing both hydroxyl and SH groups having a molecular weight of less than or equal to 700 grams/mole, and mixtures thereof.

In the foregoing non-limiting embodiment, the amount of active hydrogen-containing materials included in (b) and the amount of isocyanate or isothiocyanate or isothiocyanate/isocyanate terminated polyurethane prepolymer or sulfur-containing polyurethane prepolymer can be selected such that the equivalent ratio of (OH+SH):(NCO+NCS) can be from 1.1:1.0 to 0.85:1.0. In alternate non-limiting embodiments, said equivalent ratio of (OH+SH):(NCO+NCS) can range from 1.1:1.0 to 0.90:1.0, or from 1.1:1.0 to 0.95:1.0, or from 1.0:1.0 to 0.90:1.0, or from 1.0:1.0 to 0.95:1.0.

In alternate non-limiting embodiments, the amounts of polyisocyanate and/or polyisocthiocyanate and the amounts of trifunctional or higher-functional polyol, polythiol, and/or material containing both hydroxyl and SE groups used to prepare polyurethane prepolymer or sulfur-containing polyurethane prepolymer can be selected such that the viscosity of said prepolymer is less than 15,000 cps, or less than 8,000 cps, or less than 2,000 cps, measured at 73° C., using a Brookfield CAP 2000+ viscometer.

In a non-limiting embodiment, polyurethane of the present invention can be prepared by reacting polyisocyanate; trifunctional or higher-functional polyol having molecular weight of less than or equal to 200 grams/mole; and diol having molecular weight of less than or equal to 200 grams/mole in a one-pot process.

In a non-limiting embodiment, the sulfur-containing polyurethane of the present invention can be prepared by reacting (a) material chosen from polyisocyanate, or polyisothiocyanate, and mixtures thereof, and (b) material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, and mixtures thereof, and (c) material selected from diol having molecular weight of less than or equal to 200 grams/mole, dithiol having molecular weight of less than or equal to 600 grams/mole, difunctional material containing both hydroxyl and SH groups having molecular weight of less than or equal to 600 grams/mole, and mixtures thereof, in a one-pot process; wherein at least one of the materials included in (a), (b), and (c) is sulfur-containing. In a non-limiting embodiment, the dithiol in (c) can include dithiol oligomer having number average molecular weight of less than or equal to 600 grams/mole, wherein said dithiol oligomer constitutes less than or equal to 70 mole percent of species included in (c). In an alternate non-limiting embodiment, the ratio of the sum of the number of equivalents of the species included in (b) to the sum of the number of equivalents of the species included in (a) can be from 0.05:1.0 to 0.4:1.0.

Polyisocyanates and polyisothiocyanates useful in the preparation of the polyurethane and/or sulfur-containing polyurethane of the present invention are numerous and widely varied. Suitable polyisocyanates for use in the present invention can include but are not limited to polymeric polyisocyanates; aliphatic linear polyisocyanates; aliphatic branched polyisocyanates; cycloaliphatic polyisocyanates wherein one or more of the isocyanato groups are attached directly to the cycloaliphatic ring and cycloaliphatic polyisocyanates wherein one or more of the isocyanato groups are not attached directly to the cycloaliphatic ring; and aromatic polyisocyanates wherein one or more of the isocyanato groups are attached directly to the aromatic ring, and aromatic polyisocyanates wherein one or more of the isocyanato groups are not attached directly to the aromatic ring.

Suitable polyisothiocyanates for use in the present invention can include but are not limited to polymeric polyisothiocyanates; aliphatic linear polyisothiocyanates; aliphatic branched polyisothiocyanates; cycloaliphatic polyisothiocyanates wherein one or more of the isocyanato groups are attached directly to the cycloaliphatic ring and cycloaliphatic polyisothiocyanates wherein one or more of the isocyanato groups are not attached directly to the cycloaliphatic ring; and aromatic polyisothiocyanates wherein one or more of the isocyanato groups are attached directly to the aromatic ring, and aromatic polyisothiocyanates wherein one or more of the isocyanato groups are not attached directly to the aromatic ring.

Non-limiting examples can include polyisocyanates and polyisothiocyanates having backbone linkages chosen from urethane linkages (—NH—C(O)—O—), thiourethane linkages (—NH—C(O)—S—), thiocarbamate linkages (—NH—C(S)—O—), dithiourethane linkages (—NH—C(S)—S—) and combinations thereof.

The molecular weight of the polyisocyanate and polyisothiocyanate can vary widely. In alternate non-limiting embodiments, the number average molecular weight (Mn) of each can be at least 100 grams/mole, or at least 150 grams/mole, or less than 15,000 grams/mole, or less than 5000 grams/mole. The number average molecular weight can be determined using known methods. The number average molecular weight values recited herein and the claims were determined by gel permeation chromatography (CPC) using polystyrene standards.

Non-limiting examples of suitable polyisocyanates and polyisothiocyanates can include but are not limited to polyisocyanates having at least two isocyanate groups; polyisothiocyanates having at least two isothiocyanate groups; mixtures thereof; and combinations thereof, such as a material having both isocyanate and isothiocyanate functionality.

In a non-limiting embodiment, when using an aromatic polyisocyanate and/or polyisothiocyanate, general care should be taken to select material that does not cause the resulting polyurethane to color (e.g., yellow).

In a non-limiting embodiment of the present invention, the polyisocyanate can include but is not limited to aliphatic or cycloaliphatic diisocyanates, aromatic diisocyanates, cyclic dimers and cyclic trimers thereof, and mixtures thereof. Non-limiting examples of suitable polyisocyanates can include but are not limited to Desmodur N 3300 (hexamethylene diisocyanate trimer) which is commercially available from Bayer; Desmodur N 3400 (60% hexamethylene diisocyanate dimer and 40% hexamethylene diisocyanate trimer).

In a non-limiting embodiment, the polyisocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

In one non-limiting embodiment, three suitable isomers of 4,4′-methylenebis(cyclohexyl isocyanate) for use in the present invention are shown below.

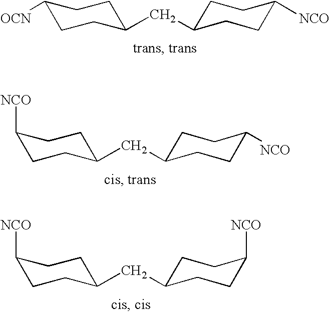

In one non-limiting embodiment, the PICM used in this invention can be prepared by phosgenating the 4,4′-methylenebis(cyclohexyl amine) (PACM) by procedures well known in the art such as the procedures disclosed in U.S. Pat. Nos. 2,644,007 and 2,680,127 which are incorporated herein by reference. The PACM isomer mixtures, upon phosgenation, can produce PICM in a liquid phase, a partially liquid phase, or a solid phase at room temperature. The PACM isomer mixtures can be obtained by the hydrogenation of methylenedianiline and/or by fractional crystallization of PACM isomer mixtures in the presence of water and alcohols such as methanol and ethanol.

In a non-limiting embodiment, the isomeric mixture can contain from 10-100 percent of the trans,trans isomer of 4,4′-methylenebis(cyclohexyl isocyanate)(PICM).

Additional aliphatic and cycloaliphatic diisocyanates that can be used in alternate non-limiting embodiments of the present invention include 3-isocyanato-methyl-3,5,5-trimethyl cyclohexyl-isocyanate (“IPDI”) which is commercially available from Arco Chemical, meta-xylylene diisocyanate (1,3-bis(isocyanato-methyl)benzene), and meta-tetramethylxylylene diisocyanate (1,3-bis(1-isocyanato-1-methylethyl)-benzene) which is commercially available from Cytec Industries Inc. under the tradename TMXDI.®. (Meta) Aliphatic Isocyanate.

Further non-limiting examples of suitable polyisocyanates can include but are not limited to ethylenically unsaturated polyisocyanates; aliphatic polyisocyanates containing sulfide linkages; aromatic polyisocyanates containing sulfide or disulfide linkages; aromatic polyisocyanates containing sulfone linkages; sulfonic ester-type polyisocyanates, e.g., 4-methyl-3-isocyanatobenzenesulfonyl-4′-isocyanato-phenol ester; aromatic sulfonic amide-type polyisocyanates; sulfur-containing heterocyclic polyisocyanates, e.g., thiophene-2,5-diisocyanate; halogenated, alkylated, alkoxylated, nitrated, carbodiimide modified, urea modified and biuret modified derivatives of polyisocyanates thereof; and dimerized and trimerized products of polyisocyanates thereof.

In a further non-limiting embodiment, a sulfur-containing polyisocyanate of the following general formula (I) can be used:

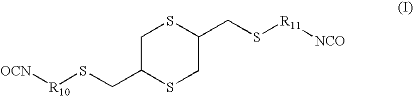

wherein R₁₀ and R₁₁ are each independently C₁ to C₃ alkyl.

Further non-limiting examples of aliphatic polyisocyanates can include ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Examples of ethylenically unsaturated polyisocyanates can include but are not limited to butene diisocyanate and 1,3-butadiene-1,4-diisocyanate. Alicyclic polyisocyanates can include but are not limited to isophorone diisocyanate, cyclohexane diisocyanate, methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]-heptane.

Examples of aromatic polyisocyanates wherein the isocyanate groups are not bonded directly to the aromatic ring can include but are not limited to α,α′-xylylene diisocyanate, bis(isocyanatoethyl)benzene, α,α,α′,α′-tetramethylxylylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, mesitylene triisocyanate and 2,5-di(isocyanatomethyl)furan. Aromatic polyisocyanates having isocyanate groups bonded directly to the aromatic ring can include but are not limited to phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene diisocyanate, benzene triisocyanate, naphthalene diisocyanate, methylnaphthalene diisocyanate, biphenyl diisocyanate, ortho-toluidine diisocyanate, ortho-tolylidine diisocyanate, ortho tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4-methyldiphenylmethane-3,5,2′,4′,6′-pentaisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate and dichlorocarbazole diisocyanate.

Further non-limiting examples of aliphatic and cycloaliphatic diisocyanates that can be used in the present invention include 3-isocyanato-methyl-3,5,5-trimethyl cyclohexyl-isocyanate (“IPDI”) which is commercially available from Arco Chemical, and meta-tetramethylxylylene diisocyanate (1,3-bis(1-isocyanato-1-methylethyl)-benzene) which is commercially available from Cytec Industries Inc. under the tradename TMXDI.®. (Meta) Aliphatic Isocyanate.

In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group.

Non-limiting examples of polyisocyanates can include aliphatic polyisocyanates containing sulfide linkages such as thiodiethyl diisocyanate, thiodipropyl diisocyanate, dithiodihexyl diisocyanate, dimethylsulfone diisocyanate, dithiodimethyl diisocyanate, dithiodiethyl diisocyanate, dithiodipropyl diisocyanate and dicyclohexylsulfide-4,4′-diisocyanate. Non-limiting examples of aromatic polyisocyanates containing sulfide or disulfide linkages include but are not limited to diphenylsulfide-2,4′-diisocyanate, diphenylsulfide-4,4′-diisocyanate, 3,3′-dimethoxy-4,4′-diisocyanatodibenzyl thioether, bis(4-isocyanatomethylbenzene)-sulfide, diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5′-diisocyanate, 3,3′-dimethoxydiphenyldisulfide-4,4′-diisocyanate and 4,4′-dimethoxydiphenyldisulfide-3,3′-diisocyanate.

Non-limiting examples polyisocyanates can include aromatic polyisocyanates containing sulfone linkages such as diphenylsulfone-4,4′-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyl-diphenylsulfone-3,3′-diisocyanate and 4,4′-dichlorodiphenylsulfone-3,3′-diisocyanate.

Non-limiting examples of aromatic sulfonic amide-type polyisocyanates for use in the present invention can include 4-methyl-3-isocyanato-benzene-sulfonylanilide-3′-methyl-4′-isocyanate, dibenzenesulfonyl-ethylenediamine-4,4′-diisocyanate, 4,4′-methoxybenzenesulfonyl-ethylenediamine-3,3′-diisocyanate and 4-methyl-3-isocyanato-benzene-sulfonylanilide-4-ethyl-3′-isocyanate.

In alternate non-limiting embodiments, the polyisothiocyanate for use in the present invention can include but are not limited to cyclohexane diisothiocyanates; aromatic polyisothiocyanates wherein the isothiocyanate groups are not bonded directly to the aromatic ring, such as but not limited to α,α′-xylylene diisothiocyanate; aromatic polyisothiocyanates wherein the isothiocyanate groups are bonded directly to the aromatic ring, such as but not limited to phenylene diisothiocyanate; heterocyclic polyisothiocyanates, such as but not limited to 2,4,6-triisothicyanato-1,3,5-triazine and thiophene-2,5-diisothiocyanate; aliphatic polyisothiocyanates containing sulfide linkages, such as but not limited to thiobis(3-isothiocyanatopropane); aromatic polyisothiocyanates containing sulfur atoms in addition to those of the isothiocyanate groups; halogenated, alkylated, alkoxylated, nitrated, carbodiimide modified, urea modified and biuret modified derivatives of these polyisothiocyanates; and dimerized and trimerized products of these polyisothiocyanates.

Non-limiting examples of aliphatic polyisothiocyanates can include 1,2-diisothiocyanatoethane, 1,3-diisothiocyanatopropane, 1,4-diisothiocyanatobutane and 1,6-diisothiocyanatohexane.

Non-limiting examples of aromatic polyisothiocyanates having isothiocyanate groups bonded directly to the aromatic ring can include but are not limited to 1,2-diisothiocyanatobenzene, 1,3-diisothiocyanatobenzene, 1,4-diisothiocyanatobenzene, 2,4-diisothiocyanatotoluene, 2,5-diisothiocyanato-m-xylene, 4,4′-diisothiocyanato-1,1′-biphenyl, 1,1′-methylenebis(4-isothiocyanatobenzene), 1,1′-methylenebis(4-isothiocyanato-2-methylbenzene), 1,1′-methylenebis(4-isothiocyanato-3-methylbenzene), 1,1′-(1,2-ethane-diyl)bis(4-isothiocyanatobenzene), 4,4′-diisothiocyanatobenzophenenone, 4,4′-diisothiocyanato-3,3′-dimethylbenzophenone, benzanilide-3,4′-diisothiocyanate, diphenylether-4,4′-diisothiocyanate and diphenylamine-4,4′-diisothiocyanate.

Non-limiting examples of aromatic polyisothiocyanates containing sulfur atoms in addition to those of the isothiocyanate groups, can include but are not limited to 1-isothiocyanato-4-[(2-isothiocyanato)sulfonyl]benzene, thiobis(4-isothiocyanatobenzene), sulfonylbis(4-isothiocyanatobenzene), sulfinylbis(4-isothiocyanatobenzene), dithiobis(4-isothiocyanatobenzene), 4-isothiocyanato-1-[(4-isothiocyanatophenyl)-sulfonyl]-2-methoxybenzene, 4-methyl-3-isothicyanatobenzene-sulfonyl-4′-isothiocyanate phenyl ester and 4-methyl-3-isothiocyanatobenzene-sulfonylanilide-3′-methyl-4′-isothiocyanate.

Non-limiting examples of materials having isocyanate and isothiocyanate groups can include materials having aliphatic, alicyclic, aromatic or heterocyclic groups and which optionally can contain sulfur atoms in addition to those of the isothiocyanate groups. Non-limiting examples of such materials can include but are not limited to 1-isocyanato-3-isothiocyanatopropane, 1-isocyanato-5-isothiocyanatopentane, 1-isocyanato-6-isothiocyanatohexane, isocyanatocarbonyl isothiocyanate, 1-isocyanato-4-isothiocyanatocyclohexane, 1-isocyanato-4-isothiocyanatobenzene, 4-methyl-3-isocyanato-1-isothiocyanatobenzene, 2-isocyanato-4,6-diisothiocyanato-1,3,5-triazine, 4-isocyanato-4′-isothiocyanato-diphenyl sulfide and 2-isocyanato-2′-isothiocyanatodiethyl disulfide.

In further alternate non-limiting embodiments, the polyisocyanate can include meta-tetramethylxylene diisocyanate (1,3-bis(1-isocyanato-1-methylethyl benzene); 3-isocyanato-methyl-3,5,5,-trimethyl cyclohexyl isocyanate; 4,4-methylene bis(cyclohexyl isocyanate); meta-xylylene diisocyanate, or mixtures thereof.

In a non-limiting embodiment of the present invention, polyisocyanate and/or polyisothiocyanate can be combined with trifunctional or higher-functional polyol and/or polythiol and allowed to react to form polyurethane prepolymer or sulfur-containing polyurethane prepolymer; and said prepolymer then can be chain extended with diol, and/or dithiol, and optionally trifunctional or higher-functional polyol and/or polythiol to form polyurethane or sulfur-containing polyurethane polymer. In another non-limiting embodiment, polyisocyanate and/or polyisothiocyanate; trifunctional or higher-functional polyol and/or polythiol; diol and/or dithiol can be combined together in a one-pot process to form polyurethane or sulfur-containing polyurethane polymer.

Active hydrogen-containing materials suitable for use in the present invention are varied and known in the art. Non-limiting examples can include hydroxyl-containing materials such as but not limited to polyols; sulfur-containing materials such as but not limited to hydroxyl functional polysulfides, and SH-containing materials such as but not limited to polythiols; and materials having both hydroxyl and thiol functional groups.

Non-limiting examples of trifunctional and higher-functional polyols for use in the present invention can include trimethylolethane, trimethylolpropane, di(trimethylolpropane), glycerol, pentaerythritol, di(pentaerythritol), cyclohexanetriol, ethoxylated trimethylolpropane, propoxylated trimethylolpropane, ethoxylated pentaerythritol, propoxylated pentaerythritol, or mixtures thereof.

Suitable diols for use in the present invention are varied and can be selected from those known in the art. Non-limiting examples can include aliphatic, cycloaliphatic, aromatic, heterocyclic, polymeric, oligomeric diols and mixtures thereof.

Non-limiting examples of diols for use in the present invention can include those disclosed in the prior art and herein. Further non-limiting examples of diols for use in the present invention can include polyester diols, polycaprolactone diols, polyether diols, and polycarbonate diols with number average molecular weights (Mₙ) ranging from 200 to 5,000 grams/mole.

Suitable diols can include materials described by the following general formula:

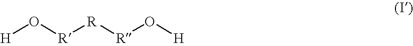

wherein R can represent C₀ to C₃₀ divalent linear or branched aliphatic, cycloaliphatic, aromatic, heterocyclic, or oligomeric saturated alkylene radical or mixtures thereof; C₂ to C₃₀ divalent organic radical containing at least one element selected from the group consisting of sulfur, oxygen and silicon in addition to carbon and hydrogen atoms; C₅ to C₃₀ divalent saturated cycloalkylene radical; C₅ to C₃₀ divalent saturated heterocycloalkylene radical; and

R′ and R″ can each independently represent C₁ to C₃₀ divalent linear or branched aliphatic, cycloaliphatic, aromatic, heterocyclic, polymeric, oligomeric saturated alkylene radical or mixtures thereof.

Non-limiting examples of diols for use in the present invention can include ethylene glycol; propylene glycol; 1,2-butanediol; 1,4-butanediol; 1,3-butanediol; 2,2,4-trimethyl-1,3-pentanediol; 1,5-pentanediol; 2,4-pentanediol; 1,6 hexanediol; 2,5-hexanediol; 2-methyl-1,3 pentanediol; 2,4-heptanediol; 2-ethyl-1,3-hexanediol; 2,2-dimethyl-1,3-propanediol; 1,4-cyclohexanediol; 2,2-dimethyl-3-hydroxypropyl-2,2-dimethyl-3-hydroxypropionate; diethylene glycol; triethylene glycol; tetraethylene glycol; dipropylene glycol; tripropylene glycol; 1,4-cyclohexanedimethanol; 1,2-bis(hydroxymethyl)cyclohexane; 1,2-bis(hydroxyethyl)-cyclohexane; bishydroxypropyl hydantoin; the alkoxylation product of 1 mole of 2,2-bis(4-hydroxyphenyl)propane (i.e., bisphenol-A) and 2 moles of propylene oxide; and mixtures thereof.

In a non-limiting embodiment, the trifunctional or higher functional polythiol for use in the present invention can include SH-containing material such as but not limited to a polythiol having at least three thiol groups. Non-limiting examples of suitable polythiols can include but are not limited to aliphatic linear or branched polythiols, cycloaliphatic polythiols, aromatic polythiols, heterocyclic polythiols, oligomeric polythiols and mixtures thereof. The polythiol can have linkages including but not limited to ether linkages (—O—), sulfide linkages (—S—), polysulfide linkages (—Sₓ—, wherein x is at least 2, or from 2 to 4) and combinations of such linkages. As used herein and the claims, the terms “thiol,” “thiol group,” “mercapto” or “mercapto group” refer to an —SH group which is capable of forming a thiourethane linkage, (i.e., —NH—C(O)—S—) with an isocyanate group or a dithiourethane linkage (i.e., —NH—C(S)—S—) with an isothiocyanate group.

Non-limiting examples of suitable trifunctional or higher functional polythiols for use in the present invention can include but are not limited to pentaerythritol tetrakis(3-mercaptopropionate), pentaerythritol tetrakis(2-mercaptoacetate), trimethylolpropane tris(3-mercaptopropionate), trimethylolpropane tris(2-mercaptoacetate), and mixtures thereof.

In a non-limiting embodiment, the trifunctional or higher functional polythiol can be chosen from materials represented by the following formula:

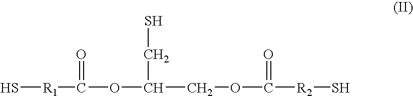

wherein R₁ and R₂ can each be independently chosen from straight or branched chain alkylene, cyclic alkylene, phenylene or C₁-C₉ alkyl substituted phenylene. Non-limiting examples of straight or branched chain alkylene can include but are not limited to methylene, ethylene, 1,3-propylene, 1,2-propylene, 1,4-butylene, 1,2-butylene, pentylene, hexylene, heptylene, octylene, nonylene, decylene, undecylene, octadecylene and icosylene. Non-limiting examples of cyclic alkylenes can include but are not limited to cyclopentylene, cyclohexylene, cycloheptylene, cyclooctylene, and alkyl-substituted derivatives thereof. In a non-limiting embodiment, the divalent linking groups R₁ and R₂ can be chosen from phenylene and alkyl-substituted phenylene, such as methyl, ethyl, propyl, isopropyl and nonyl substituted phenylene. In further non-limiting embodiments, R₁ and R₂ are each methylene or ethylene.

The polythiol represented by Formula (II) can be prepared by any known method. In a non limiting embodiment, the polythiol of Formula (II) can be prepared from an esterification or transesterification reaction between 3-mercapto-1,2-propanediol (Chemical Abstract Service (CAS) Registry No. 96-27-5) and a thiol functional carboxylic acid or carboxylic acid ester in the presence of a strong acid catalyst, such as but not limited to methane sulfonic acid, with concurrent removal of water or alcohol from the reaction mixture. A non-limiting example of a polythiol of Formula (II) includes a structure wherein R₁ and R₂ are each methylene.

It is contemplated that suitable tri-functional or higher-functional polythiols for use in the present invention can include but are not limited to polythiol oligomers having disulfide linkages, which may be prepared from the reaction of a polythiol having at least three thiol groups and sulfur in the presence of basic catalyst. In a non-limiting embodiment, the equivalent ratio of polythiol monomer to sulfur can be from m to (m−1) wherein m can represent an integer from 2 to 21. The tri-functional or higher-functional polythiol can be chosen from the above-mentioned non-limiting examples, such as but not limited to sulfur-containing polythiols represented by Formula (II) as previously disclosed. In alternate non-limiting embodiments, the sulfur can be in the form of crystalline, colloidal, powder or sublimed sulfur, and can have a purity of at least 95 percent or at least 98 percent.

In a non-limiting embodiment, the polythiol represented by Formula (II) can be thioglycerol bis(2-mercaptoacetate). As used herein and the claims, the term “thioglycerol bis(2-mercaptoacetate)” refers to any related co-product oligomeric species and polythiol monomer compositions containing residual starting materials. In a non-limiting embodiment, oxidative coupling of thiol groups can occur when washing the reaction mixture as a result of esterification of 3-mercapto-1,2-propanediol and a thiol functional carboxylic acid such as but not limited to 2-mercaptoacetic acid, with excess base such as but not limited to aqueous ammonia. Such an oxidative coupling can result in the formation of oligomeric polythiol having disulfide linkages, such as but not limited to —S—S— linkages. Non-limiting examples of such an oligomeric polythiols can include materials represented by the following formula:

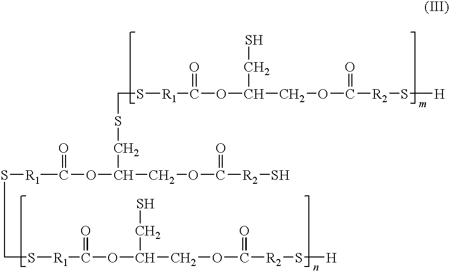

wherein R₁ and R₂ can be as described above in Formula (II), n and m can be independently an integer from 0 to 21 and (n+m) can be at least 1.

In another non-limiting embodiment, the polythiol for use in the present invention can include a material represented by the following structural formula:

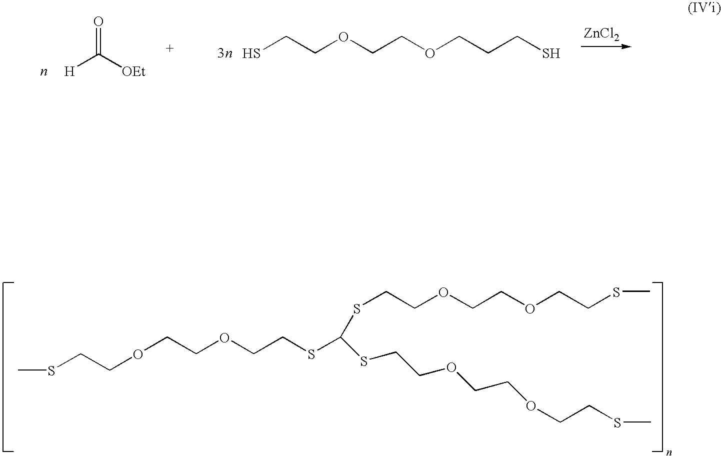

wherein n can be an integer from 1 to 20.

Various methods of preparing the polythiol of the formula (IV′i) are described in detail in U.S. Pat. No. 5,225,472, from column 2, line 8 to column 5, line 8.

In a non-limiting embodiment, 1,8-dimercapto-3,6-dioxaooctane (DMDO) can be reacted with ethyl formate in the presence of anhydrous zinc chloride, as shown above.

In another non-limiting embodiment, the polythiol for use in the present invention can include a material represented by the following structural formula and reaction scheme.

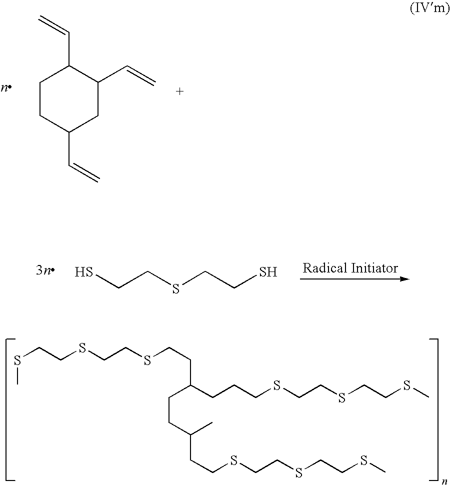

where n can be an integer from 1 to 20.

The polythiol of formula (IV′m) can be prepared by reacting one mole of 1,2,4-trivinylcyclohexane with three moles of dimercaptodiethylsulfide (DMDS), and heating the mixture in the presence of a suitable free radical initiator, such as but not limited to VAZO 64.

Suitable dithiols for use in the present invention are varied and known in the art; and can be selected from those disclosed herein. Non-limiting examples can include linear or branched aliphatic, cycloaliphatic, aromatic, heterocyclic, polymeric, oligomeric dithiols and mixtures thereof.

In a non-limiting embodiment, the dithiol for use in the present invention can include a SH-containing material such as but not limited to a polythiol having two thiol groups. The dithiol can have linkages including but not limited to ether linkages (—O—), sulfide linkages (—S—), polysulfide linkages (—Sₓ—, wherein x is at least 2, or from 2 to 4) and combinations of such linkages.

Non-limiting examples of suitable dithiols for use in the present invention can include but are not limited to 2,5-dimercaptomethyl 1,4-dithiane, dimercaptoethylsulfide, ethanedithiol, 3,6-dioxa-1,8-octanedithiol, ethylene glycol di(2-mercaptoacetate), ethylene glycol di(3-mercaptopropionate), polylethylene glycol) di(2-mercaptoacetate) and polylethylene glycol) di(3-mercaptopropionate), benzenedithiol, 4-tert-butyl-1,2-benzenedithiol, 4,4′-thiodibenzenethiol, and mixtures thereof.

In another non-limiting embodiment, the dithiol can include dithiol oligomer having disulfide linkages such as materials represented by the following formula:

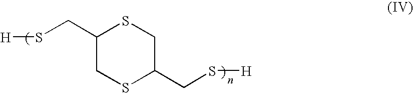

wherein n can represent an integer from 1 to 21.

In a non-limiting embodiment, dithiol oligomer represented by Formula IV can be prepared by the reaction of 2,5-dimeracaptomethyl-1,4-dithiane with sulfur in the presence of basic catalyst, as described previously herein.

The nature of the SH group of polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a possible mechanism for the oxidative coupling of thiol groups involves the formation of thiyl radicals, followed by coupling of said thiyl radicals, to form disulfide linkage. It is further believed that formation of disulfide linkage can occur under conditions that can lead to the formation of thiyl radical, including but not limited to reaction conditions involving free radical initiation.

In a non-limiting embodiment, the polythiol for use in the present invention can include species containing disulfide linkage formed during storage.

In another non-limiting embodiment, the polythiol for use in the present invention can include species containing disulfide linkage formed during synthesis of said polythiol.

In a non-limiting embodiment, the dithiol for use in the present invention, can include at least one dithiol represented by the following structural formulas.

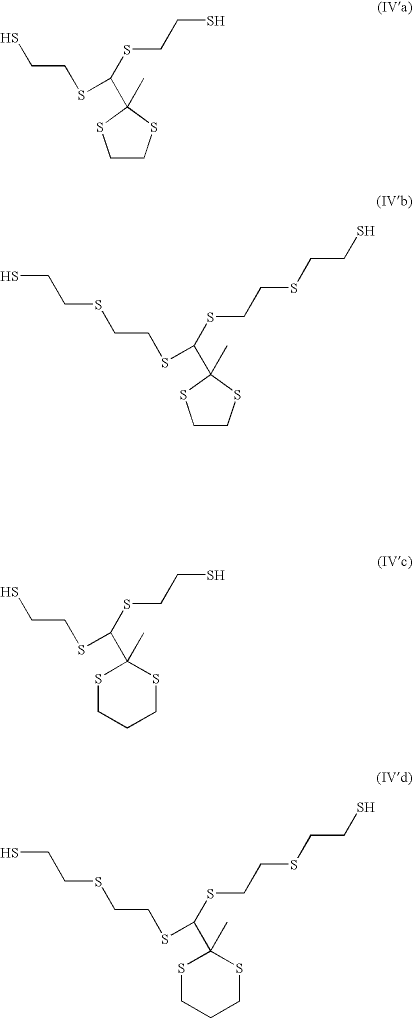

The sulfide-containing dithiols comprising 1,3-dithiolane (e.g., formulas IV′a and b) or 1,3-dithiane (e.g., formulas IV′c and d) can be prepared by reacting asym-dichloroacetone with dimercaptan, and then reacting the reaction product with dimercaptoalkylsulfide, dimercaptan or mixtures thereof.

Non-limiting examples of suitable dimercaptans for use in the reaction with asym-dichloroacetone can include but are not limited to materials represented by the following formula,

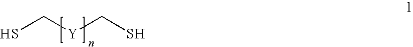

wherein Y can represent CH₂ or (CH₂—S—CH₂), and n can be an integer from 0 to 5. In a non-limiting embodiment, the dimercaptan for reaction with asym-dichloroacetone in the present invention can be chosen from ethanedithiol, propanedithiol, and mixtures thereof.

The amount of asym-dichloroacetone and dimercaptan suitable for carrying out the above reaction can vary. In a non-limiting embodiment, asym-dichloroacetone and dimercaptan can be present in the reaction mixture in an amount such that the molar ratio of dichloroacetone to dimercaptan can be from 1:1 to 1:10.

Suitable temperatures for reacting asym-dichloroacetone with dimercaptan can vary. In a non-limiting embodiment, the reaction of asym-dichloroacetone with dimercaptan can be carried out at a temperature within the range of from 0 to 100° C.

Non-limiting examples of suitable dimercaptans for use in the reaction with the reaction product of the asym-dichloroacetone and dimercaptan, can include but are not limited to materials represented by the above general formula 1, aromatic dimercaptans, cycloalkyl dimercaptans, heterocyclic dimercaptans, branched dimercaptans, and mixtures thereof.

Non-limiting examples of suitable dimercaptoalkylsulfides for use in the reaction with the reaction product of the asym-dichloroacetone and dimercaptan, can include but are not limited to materials represented by the following formula,

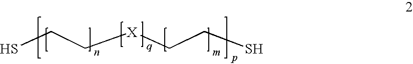

wherein X can represent O, S or Se, n can be an integer from 0 to 10, m can be an integer from 0 to 10, p can be an integer from 1 to 10, q can be an integer from 0 to 3, and with the proviso that (m+n) is an integer from 1 to 20.

Non-limiting examples of suitable dimercaptoalkylsulfides for use in the present invention can include branched dimercaptoalkylsulfides. In a non-limiting embodiment, the dimercaptoalkylsulfide for use in the present invention can be dimercaptoethylsulfide.

The amount of dimercaptan, dimercaptoalkylsulfide, or mixtures thereof, suitable for reacting with the reaction product of asym-dichloroacetone and dimercaptan, can vary. In a non-limiting embodiment, dimercaptan, dimercaptoalkylsulfide, or a mixture thereof, can be present in the reaction mixture in an amount such that the equivalent ratio of reaction product to dimercaptan, dimercaptoalkylsulfide, or a mixture thereof, can be from 1:1.01 to 1:2. Moreover, suitable temperatures for carrying out this reaction can vary. In a non-limiting embodiment, the reaction of dimercaptan, dimercaptoalkylsulfide, or a mixture thereof, with the reaction product can be carried out at a temperature within the range of from 0 to 100° C.

In a non-limiting embodiment, the reaction of asym-dichloroacetone with dimercaptan can be carried out in the presence of an acid catalyst. The acid catalyst can be selected from a wide variety known in the art, such as but not limited to Lewis acids and Bronsted acids. Non-limiting examples of suitable acid catalysts can include those described in Ullmann's Encyclopedia of Industrial Chemistry, 5^{th} Edition, 1992, Volume A21, pp. 673 to 674. In further alternate non-limiting embodiments, the acid catalyst can be chosen from boron trifluoride etherate, hydrogen chloride, toluenesulfonic acid, and mixtures thereof.

The amount of acid catalyst can vary. In a non-limiting embodiment, a suitable amount of acid catalyst can be from 0.01 to 10 percent by weight of the reaction mixture.

In another non-limiting embodiment, the reaction product of asym-dichloroacetone and dimercaptan can be reacted with dimercaptoalkylsulfide, dimercaptan or mixtures thereof, in the presence of a base. The base can be selected from a wide variety known in the art, such as but not limited to Lewis bases and Bronsted bases. Non-limiting examples of suitable bases can include those described in Ullmann's Encyclopedia of Industrial Chemistry, 5^{th} Edition, 1992, Volume A21, pp. 673 to 674. In a further non-limiting embodiment, the base can be sodium hydroxide.

The amount of base can vary. In a non-limiting embodiment, a suitable equivalent ratio of base to reaction product of the first reaction, can be from 1:1 to 10:1.

In another non-limiting embodiment, the preparation of these sulfide-containing dithiols can include the use of a solvent. The solvent can be selected from a wide variety known in the art.

In a further non-limiting embodiment, the reaction of asym-dichloroacetone with dimercaptan can be carried out in the presence of a solvent. The solvent can be selected from a wide variety of known materials. In a non-limiting embodiment, the solvent can be selected from but is not limited to organic solvents, including organic inert solvents. Non-limiting examples of suitable solvents can include but are not limited to chloroform, dichloromethane, 1,2-dichloroethane, diethyl ether, benzene, toluene, acetic acid and mixtures thereof. In still a further embodiment, the reaction of asym-dichloroacetone with dimercaptan can be carried out in the presence of toluene as solvent.

In another embodiment, the reaction product of asym-dichloroacetone and dimercaptan can be reacted with dimercaptoalkylsulfide, dimercaptan or mixtures thereof, in the presence of a solvent, wherein the solvent can be selected from but is not limited to organic solvents including organic inert solvents. Non-limiting examples of suitable organic and inert solvents can include alcohols such as but not limited to methanol, ethanol and propanol; aromatic hydrocarbon solvents such as but not limited to benzene, toluene, xylene; ketones such as but not limited to methyl ethyl ketone; water and mixtures thereof. In a further non-limiting embodiment, this reaction can be carried out in the presence of a mixture of toluene and water as solvent system. In another non-limiting embodiment, this reaction can be carried out in the presence of ethanol as solvent.

The amount of solvent can widely vary. In a non-limiting embodiment, a suitable amount of solvent can be from 0 to 99 percent by weight of the reaction mixture. In a further non-limiting embodiment, the reaction can be carried out neat, i.e., without solvent.

In another non-limiting embodiment, the reaction of asym-dichloroacetone with dimercaptan can be carried out in the presence of a dehydrating reagent. The dehydrating reagent can be selected from a wide variety known in the art. Suitable dehydrating reagents for use in this reaction can include but are not limited to magnesium sulfate. The amount of dehydrating reagent can vary widely according to the stoichiometry of the dehydrating reaction.

In a non-limiting embodiment, a sulfide-containing dithiol of the present invention can be prepared by reacting 1,1-dichloroacetone with 1,2-ethanedithiol to produce 2-methyl-2-dichloromethyl-1,3-dithiolane, as shown below.

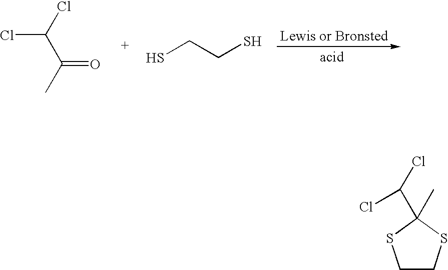

In a further non-limiting embodiment, 1,1-dichloroacetone can be reacted with 1,3-propanedithiol to produce 2-methyl-2-dichloromethyl-1,3-dithiane, as shown below.

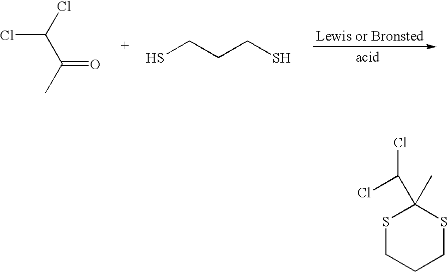

In another non-limiting embodiment, 2-methyl-2-dichloromethyl-1,3-dithiolane can be reacted with dimercaptoethylsulfide to produce dimercapto 1,3-dithiolane derivative as shown below.

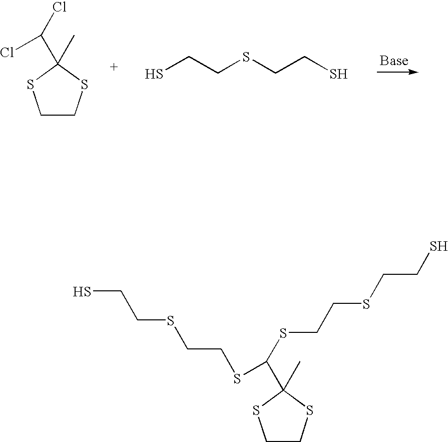

In another non-limiting embodiment, 2-methyl-2-dichloromethyl-1,3-dithiolane can be reacted with 1,2-ethanedithiol to produce dimercapto 1,3-dithiolane derivative as shown below.

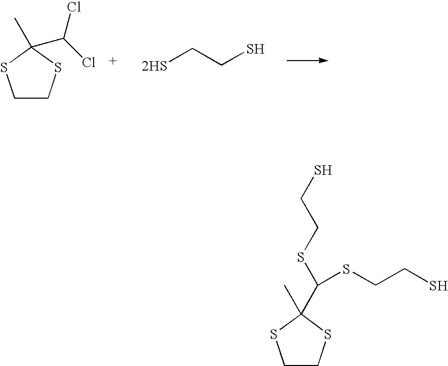

In another non-limiting embodiment, 2-methyl-2-dichloromethyl-1,3-dithiane can be reacted with dimercaptoethylsulfide to produce dimercapto 1,3-dithiane derivative as shown below.

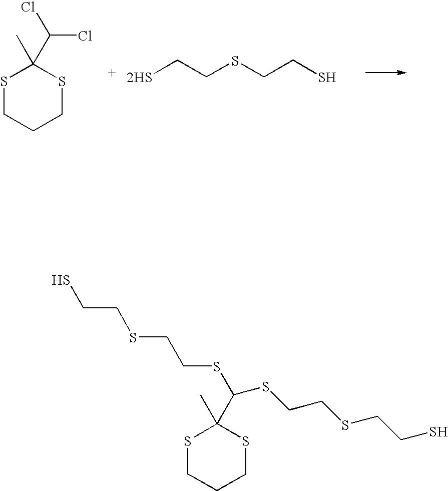

In another non-limiting embodiment, 2-methyl-2-dichloromethyl-1,3-dithiane can be reacted with 1,2-ethanedithiol to produce dimercapto 1,3-dithiane derivative as shown below.

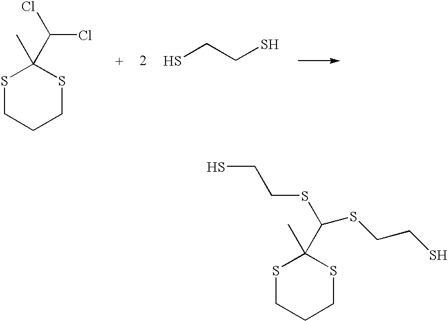

In another non-limiting embodiment, the dithiol for use in the present invention can include at least one dithiol oligomer prepared by reacting asym-dichloro derivative with dimercaptoalkylsulfide as follows:

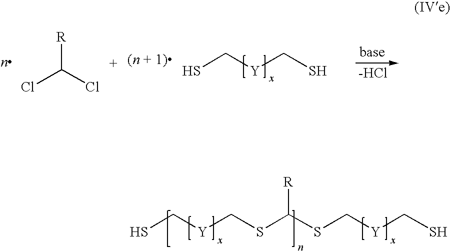

wherein R can represent CH₃, CH₃CO, C₁ to C₁₀ alkyl, cycloalkyl, aryl alkyl, or alkyl-CO; Y can represent C₁ to C₁₀ alkyl, cycloalkyl, C₆ to C₁₄ aryl, (CH₂)ₚ(S)ₘ(CH₂)_{q}, (CH₂)ₚ(Se)ₘ(CH₂)_{q}, (CH₂)ₚ(Te)ₘ(CH₂)_{q} wherein m can be an integer from 1 to 5 and, p and q can each be an integer from 1 to 10; n can be an integer from 1 to 20; and x can be an integer from 0 to 10.

In a further non-limiting embodiment, a polythioether dithiol oligomer can be prepared by reacting asym-dichloroacetone with dimercaptoalkylsulfide, in the presence of a base. Non-limiting examples of suitable dimercaptoalkylsulfides for use in this reaction can include but are not limited to those materials represented by general formula 2 as previously recited herein. Suitable bases for use in this reaction can include those previously recited herein.

Further non-limiting examples of suitable dimercaptoalkylsulfides can include branched dimercaptoalkylsulfides. In a non-limiting embodiment, the dimercaptoalkylsulfide can be dimercaptoethylsulfide.

In a non-limiting embodiment, the reaction of asym-dichloro derivative with dimercaptoalkylsulfide can be carried out in the presence of a base. Non-limiting examples of suitable bases can include those previously recited herein.

In another non-limiting embodiment, the reaction of asym-dichloro derivative with dimercaptoalkylsulfide can be carried out in the presence of a phase transfer catalyst. Suitable phase transfer catalysts for use in the present invention are known and varied. Non-limiting examples can include but are not limited to tetraalkylammonium salts and tetraalkylphosphonium salts. In a further non-limiting embodiment, this reaction can be carried out in the presence of tetrabutylphosphonium bromide as phase transfer catalyst. The amount of phase transfer catalyst can vary widely. In a non-limiting embodiment, the amount of phase transfer catalyst can be from 0 to 50 equivalent percent, or from 0 to 10 equivalent percent, or from 0 to 5 equivalent percent, to the dimercaptosulfide reactants.

In another non-limiting embodiment, the preparation of the polythioether dithiol oligomer can include the use of solvent. Non-limiting examples of suitable solvents can include those previously recited herein.

In a non-limiting embodiment, “n” moles of 1,1-dichloroacetone can be reacted with “n+1” moles of dimercaptoethylsulfide wherein n can represent an integer of from 1 to 20, to produce a polythioether dithiol oligomer as follows:

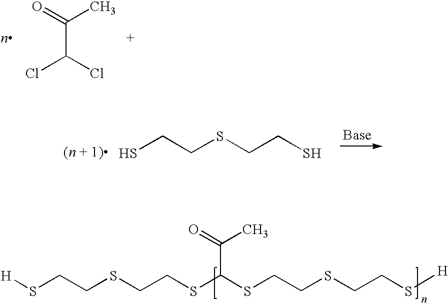

In a further non-limiting embodiment, polythioether dithiol oligomer can be prepared by introducing “n” moles of 1,1-dichloroethane together with “n+1” moles of dimercaptoethylsulfide as follows:

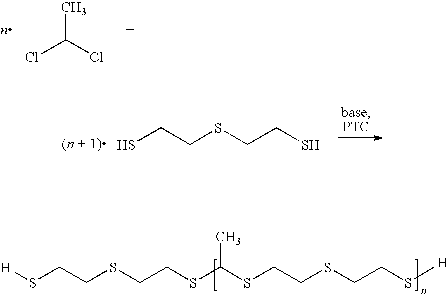

wherein n can represent an integer from 1 to 20.

In a non-limiting embodiment, dithiol for use in the present invention can include dithiol oligomer formed by the reaction of dithiol with diene, via the thiol-ene type reaction of the SH groups of said dithiol with double bond groups of said diene.

In alternate non-limiting embodiments, the dithiol for use in the present invention can include at least one dithiol oligomer represented by the following structural formulas and prepared by the following methods.

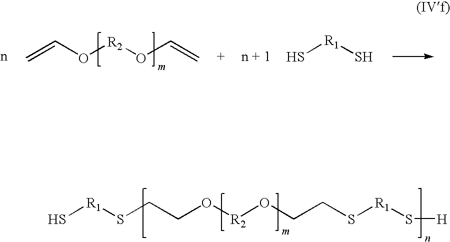

wherein R₁ can be selected from C₂ to C₆ n-alkylene, C₃ to C₆ branched alkylene, having one or more pendant groups which can include but are not limited to hydroxyl, alkyl such as methyl or ethyl; alkoxy, thioalkyl, or C₆ to C₈ cycloalkylene; R₂ can be selected from C₂ to C₆ n-alkylene, C₂ to C₆ branched alkylene, C₆ to C₈ cycloalkylene or C₆ to C₁₀ alkylcycloalkylene group or —[(CH₂—)ₚ—O—]_{q}—(—CH₂—)ᵣ m can be a rational number from 0 to 10, n can be an integer from 1 to 20, p can be an integer from 2 to 6, q can be an integer from 1 to 5, and r can be an integer from 2 to 10.

Various methods of preparing the dithiol of formula (IV′f) are described in detail in U.S. Pat. No. 6,509,418B1, column 4, line 52 through column 8, line 25, which disclosure is herein incorporated by reference. In general, this dithiol can be prepared by reacting reactants comprising one or more polyvinyl ether monomer, and one or more dithiol material. Useful polyvinyl ether monomers can include but are not limited to divinyl ethers represented by structural formula (V′):

CH₂═CH—O—(—R²—O—)ₘ—CH═CH₂ (V′)

wherein R² can be selected from C₂ to C₆ n-alkylene, C₂ to C₆ branched alkylene, C₆ to C₈ cycloalkylene or C₆ to C₁₀ alkylcycloalkylene group or —[(CH₂—)ₚ—O—]_{q}—(—CH₂—)ᵣ—, m can be a rational number from 0 to 10, p can be an integer from 2 to 6, q can be an integer from 1 to 5 and r can be an integer from 2 to 10.

In a non-limiting embodiment, m can be two (2).

Non-limiting examples of suitable polyvinyl ether monomers for use can include divinyl ether monomers, such as but not limited to ethylene glycol divinyl ether, diethylene glycol divinyl ether and butane diol divinyl ether.

The divinyl ether of formula (V′) can be reacted with a polythiol such as but not limited to a dithiol having the formula (VI′):

HS—R1-SH (VI′)

wherein R1 can be selected from C₂ to C₆ n-alkylene; C₃ to C₆ branched alkylene, having one or more pendant groups which can include but are not limited to hydroxyl, alkyl such as methyl or ethyl; alkoxy, thioalkyl, or C₆ to C₈ cycloalkylene.

Non-limiting examples of suitable dithiols represented by Formula (VI′) can include but are not limited to dithiols such as 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 1,5-dimercapto-3-oxapentane and mixtures thereof. In a non-limiting embodiment, the dithiol of formula (VI′) can be dimercaptodiethylsulfide (DMDS).

In a further non-limiting embodiment, the stoichiometric ratio of dithiol to divinyl ether materials can be less than one equivalent of polyvinyl ether to one equivalent of dithiol.

In a non-limiting embodiment, the reactants used in producing dithiol represented by Formula (VI′f) can further include one or more free radical catalysts. Non-limiting examples of suitable free radical catalysts can include azo compounds, such as azobis-nitrile compounds such as but not limited to azo(bis)isobutyronitrile (AIBN); organic peroxides such as but not limited to benzoyl peroxide and t-butyl peroxide; inorganic peroxides and similar free-radical generators.

In alternate non-limiting embodiments, the reaction to produce the material represented by Formula (VI′f) can be effected by irradiation with ultraviolet light either with or without a cationic photoinitiating moiety.

In a non-limiting embodiment, the dithiol for use in the present invention can include a material having the following structural formula and prepared by the following reaction:

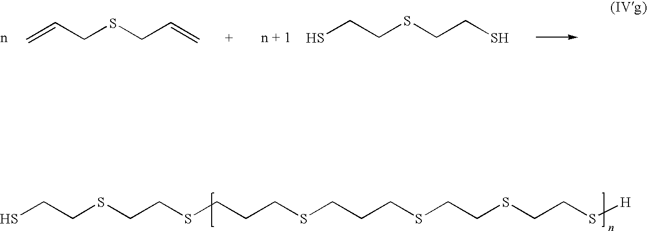

wherein n can be an integer from 1 to 20.

Various methods of preparing the dithiol of the formula (IV′g) are described in detail in WO 03/042270, page 2, line 16 to page 10, line 7, which disclosure is incorporated herein by reference. The dithiol can be prepared by ultraviolet (UV) catalyzed free radical polymerization in the presence of a suitable photoinitiator. Suitable photoinitiators in usual amounts as known to one skilled in the art can be used for this process. In a non-limiting embodiment, 1-hydroxycyclohexyl phenyl ketone (Irgacure 184) can be used in an amount of from 0.05% to 0.10% by weight, based on the total weight of the polymerizable monomers present in the mixture.

In a non-limiting embodiment, the dithiol of the formula (IV′g) can be prepared by reacting “n” moles of allyl sulfide and “n+1” moles of dimercaptodiethylsulfide as shown above.

In a non-limiting embodiment, the dithiol for use in the present invention can include a material represented by the following structural formula and prepared by the following reaction:

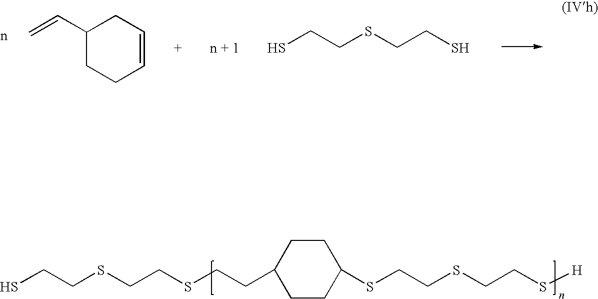

wherein n can be an integer from 1 to 20.

Various methods for preparing the dithiol of formula (IV′h) are described in detail in WO/01/66623A1, from page 3, line 19 to page 6, line 11, the disclosure of which is incorporated herein by reference. In general, this dithiol can be prepared by the reaction of a dithiol, and an aliphatic, ring-containing non-conjugated diene in the presence of free radical initiator. Non-limiting examples of suitable dithiols for use in the reaction can include but are not limited to lower alkylene dithiols such as ethanedithiol, vinylcyclohexyldithiol, dicyclopentadienedithiol, dipentene dimercaptan, and hexanedithiol; polyol esters of thioglycolic acid and thiopropionic acid.

Non-limiting examples of suitable cyclodienes can include but are not limited to vinylcyclohexene, dipentene, dicyclopentadiene, cyclododecadiene, cyclooctadiene, 2-cyclopenten-1-yl-ether, 5-vinyl-2-norbornene and norbornadiene.

Non-limiting examples of suitable free radical initiators for the reaction can include azo or peroxide free radical initiators such as the azobisalkylenenitrile commercially available from DuPont under the trade name VAZO™.

In a further non-limiting embodiment, the reaction of dimercaptoethylsulfide with 4-vinyl-1-cyclohexene can include VAZO-52 free radical initiator.

In a non-limiting embodiment, the dithiol for use in the present invention can include a material represented by the following structural formula and reaction scheme:

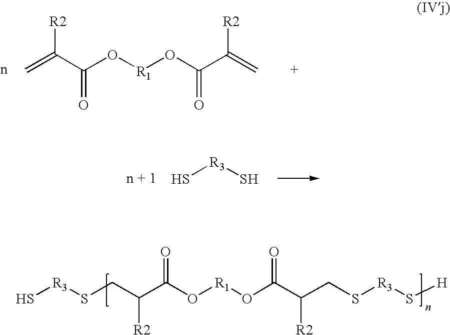

wherein R₁ and R₃ can be independently chosen from C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, alkyl groups containing ether linkages or thioether linkages or ester linkages or thioester linkages or combinations thereof, —[(CH₂—)ₚ—X—]_{q}—(—CH₂—)ᵣ—, wherein X can be O or S, p can be an integer from 2 to 6, q can be an integer from 1 to 5, r can be an integer from 0 to 10; R₂ can be selected from hydrogen or methyl; and n can be an integer from 1 to 20.

In general, the dithiol of formula (IV′j) can be prepared by reacting di(meth)acrylate monomer and one or more polythiols. Non-limiting examples of suitable di(meth)acrylate monomers can vary widely and can include those known in the art, such as but not limited to ethylene glycol di(meth)acrylate, 1,3-butylene glycol di(meth)acrylate, 1,4-butanediol di(meth)acrylate, 2,3-dimethyl-1,3-propanediol di(meth)acrylate, 1,6-hexanediol di(meth)acrylate, propylene glycol di(meth)acrylate, dipropylene glycol di(meth)acrylate, tripropylene glycol di(meth)acrylate, tetrapropylene glycol di(meth)acrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, polyethylene glycol di(meth)acrylate, thiodiethyleneglycol di(meth)acrylate, trimethylene glycol di(meth)acrylate, triethylene glycol di(meth)acrylate, alkoxylated hexanediol di(meth)acrylate, alkoxyolated neopentyl glycol di(meth)acrylate, pentanediol di(meth)acrylate, cyclohexane dimethanol di(meth)acrylate, ethoxylated bis-phenol A di(meth)acrylate.

Non-limiting examples of suitable dithiols for use in preparing the dithiol of formula (IV′j) can vary widely and can include those known in the art, such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide (DMDS), methyl-substituted dimercaptodiethylsulfide, dimethyl-substituted dimercaptodiethylsulfide, dimercaptodioxaoctane, 3,6-dioxa, 1,8-octanedithiol, 2-mercaptoethyl ether, 1,5-dimercapto-3-oxapentane, 2,5-dimercaptomethyl-1,4-dithiane (DMMD), ethylene glycol di(2-mercaptoacetate), ethylene glycol di(3-mercaptopropionate), and mixtures thereof.

In a non-limiting embodiment, the di(meth)acrylate used to prepare the dithiol of formula (IV′j) can be ethylene glycol di(meth)acrylate.

In another non-limiting embodiment, the dithiol used to prepare the dithiol of formula (IV′j) can be dimercaptodiethylsulfide (DMDS).

In a non-limiting embodiment, the reaction to produce the dithiol of formula (IV′j) can be carried out in the presence of base catalyst. Suitable base catalysts for use in this reaction can vary widely and can be selected from those known in the art. Non-limiting examples can include but are not limited to tertiary amine bases such as 18-diazabicyclo[5.4.0]undec-7-ene (DBU) and N,N-dimethylbenzylamine. The amount of base catalyst used can vary widely. In a non-limiting embodiment, the base catalyst can be present in an amount of from 0.001 to 5.0% by weight of the reaction mixture.

Not intending to be bound by any particular theory, it is believed that as the mixture of dithiol, di(meth)acrylate monomer, and base catalyst is reacted, the double bonds can be at least partially consumed by reaction with the SH groups of the pdithiol. In a non-limiting embodiment, the mixture can be reacted for a period of time such that the double bonds are substantially consumed and a desired theoretical value for SH content is achieved. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, the mixture can be reacted until a theoretical value for SH content of from 0.5% to 20% is achieved.

The number average molecular weight (Mₙ) of the resulting dithiol oligomer can vary widely. In a non-limiting embodiment, the number average molecular weight (Mₙ) of dithiol oligomer can be determined by the stoichiometry of the reaction. In alternate non-limiting embodiments, the Mₙ of dithiol oligomer can be at least 250 grams/mole, or less than or equal to 3000 grams/mole, or from 250 to 2000 grams/mole, or from 250 to 1500 grams/mole.

In a non-limiting embodiment, the dithiol for use in the present invention can include a material represented by the following structural formula and reaction scheme:

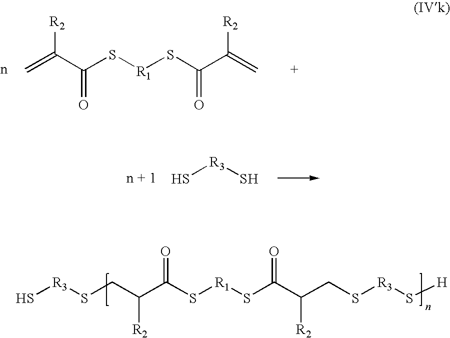

wherein R₁ and R₃ each can be independently selected from C₁ to C₆ n-alkylene, C₂ to C₆, branched alkylene, C₆ to C₈ cycloalkylene, C₆ to C₁₀ alkylcycloalkylene, C₆ to C₈ aryl, C₆ to C₁₀ alkyl-aryl, alkyl groups containing ether linkages or thioether linkages or ester linkages or thioester linkages or combinations thereof, —[(CH₂—)ₚ—X—]_{q}—(—CH₂—)ᵣ—, wherein X can be O or S, p can be an integer from 2 to 6, q can be an integer from 1 to 5, r can be an integer from 0 to 10; R₂ can be selected from hydrogen or methyl; and n can be an integer from 1 to 20.

In general, the dithiol of formula (IV′k) can be prepared by reacting dithio(meth)acrylate monomer, and one or more dithiols. Non-limiting examples of suitable dithio(meth)acrylate monomers can vary widely and can include those known in the art, such as but not limited to the di(meth)acrylate of 1,2-ethanedithiol including oligomers thereof, the di(meth)acrylate of dimercaptodiethyl sulfide (i.e., 2,2′-thioethanedithiol di(meth)acrylate) including oligomers thereof, the di(meth)acrylate of 3,6-dioxa-1,8-octanedithiol including oligomers thereof, the di(meth)acrylate of 2-mercaptoethyl ether including oligomers thereof, the di(meth)acrylate of 4,4′-thiodibenzenethiol, and mixtures thereof.

The dithio(meth)acrylate monomer can be prepared from dithiol using methods known to those skilled in the art, including but not limited to those methods disclosed in U.S. Pat. No. 4,810,812, U.S. Pat. No. 6,342,571; and WO 03/011925. Non-limiting examples of suitable dithiol materials for use in preparing the dithiol of structure (IV′k) can include a wide variety of dithiols known in the art, such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 3,6-dioxa, 1,8-octanedithiol, 2-mercaptoethyl ether, 1,5-dimercapto-3-oxapentane, 2,5-dimercaptomethyl-1,4-dithiane (DMMD), ethylene glycol di(2-mercaptoacetate), ethylene glycol di(3-mercaptopropionate, and mixtures thereof.

In a non-limiting embodiment, the dithio(meth)acrylate used to prepare the polythiol of formula (IV′k) can be the di(meth)acrylate of dimercaptodiethylsulfide, i.e., 2,2′-thiodiethanethiol dimethacrylate. In another non-limiting embodiment, the dithiol used to prepare the dithiol of formula (IV′k) can be dimercaptodiethylsulfide (DMDS).

In a non-limiting embodiment, this reaction can be carried out in the presence of base catalyst. Non-limiting examples of suitable base catalysts for use can vary widely and can be selected from those known in the art. Non-limiting examples can include but are not limited to tertiary amine bases such as 1,8-diazabicyclo[5.4.0]undec-7-ene (DBU) and N,N-dimethylbenzylamine.

The amount of base catalyst used can vary widely. In a non-limiting embodiment, the base catalyst can be present in an amount of from 0.001 to 5.0% by weight of the reaction mixture. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, the mixture can be heated until a theoretical value for SH content of from 0.5% to 20% is achieved.

The number average molecular weight (Mₙ) of the resulting dithiol oligomer can vary widely. In a non-limiting embodiment, the number average molecular weight (Mₙ) of dithiol oligomer can be determined by the stoichiometry of the reaction. In alternate non-limiting embodiments, the Mₙ of dithiol oligomer can be at least 250 grams/mole, or less than or equal to 3000 grams/mole, or from 250 to 2000 grams/mole, or from 250 to 1500 grams/mole.

In a non-limiting embodiment, the dithiol for use in the present invention can include a material represented by the following structural formula and reaction:

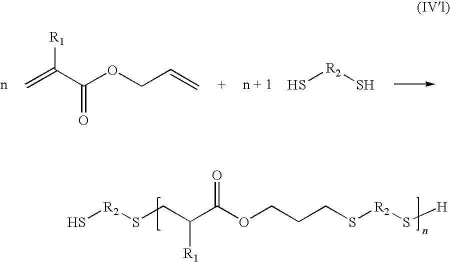

wherein R₁ can be selected from hydrogen or methyl, and R₂ can be selected from C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, alkyl groups containing ether linkages or thioether linkages or ester linkages or thioester linkages or combinations thereof, or —[(CH₂—)ₚ—X—]_{q}—(—CH₂—)ᵣ—, wherein X can be selected from O or S, p can be an integer from 2 to 6, q can be an integer from 1 to 5, r can be an integer from 0 to 10; and n can be an integer from 1 to 20.

In general, the dithiol of formula (IV′1) can be prepared by reacting allyl(meth)acrylate, and one or more dithiols. Non-limiting examples of suitable dithiols for use in preparing the dithiol of structure (IV′1) can include a wide variety of known dithiols such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 3,6-dioxa, 1,8-octanedithiol, 2 mercaptoethyl ether, 1,5-dimercapto-3-oxapentane, 2,5-dimercaptomethyl-1,4-dithiane, ethylene glycol di(2-mercaptoacetate), ethylene glycol di(3-mercaptopropionate), 4-tert-butyl-1,2-benzenedithiol, benzene dithiol, 4,4′-thiodibenzenethiol, and mixtures thereof.

In a non-limiting embodiment, the dithiol used to prepare the dithiol of formula (IV′1) can be dimercaptodiethylsulfide (DMDS).

In a non-limiting embodiment, the (meth)acrylic double bonds of allyl (meth)acrylate can be first reacted with dithiol in the presence of base catalyst. Non-limiting examples of suitable base catalysts can vary widely and can be selected from those known in the art. Non-limiting examples can include but are not limited to tertiary amine bases such as 1,8-diazabicyclo[5.4.0]undec-7-ene (DBU) and N,N-dimethylbenzylamine. The amount of base catalyst used can vary widely. In a non-limiting embodiment, the base catalyst can be present in an amount of from 0.001 to 5.0% by weight of the reaction mixture. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, following reaction of the SH groups of the dithiol with substantially all of the available (meth)acrylate double bonds of the allyl (meth)acrylate, the allyl double bonds can then be reacted with the remaining SH groups in the presence of radical initiator. Not intending to be bound by any particular theory, it is believed that as the mixture is heated, the allyl double bonds can be at least partially consumed by reaction with the remaining SH groups. Non-limiting examples of suitable radical initiators can include but are not limited to azo or peroxide type free-radical initiators such as azobisalkylenenitriles. In a non-limiting embodiment, the free-radical initiator can be azobisalkylenenitrile which is commercially available from DuPont under the trade name VAZO™. In alternate non-limiting embodiments, VAZO-52, VAZO-64, VAZO-67, or VAZO-88 catalysts can be used as radical initiators.

In a non-limiting embodiment, the mixture can be heated for a period of time such that the double bonds are substantially consumed and a desired theoretical value for SH content is achieved. In a non-limiting embodiment, the mixture can be heated for a time period of from 1 hour to 5 days. In another non-limiting embodiment, the mixture can be heated at a temperature of from 40° C. to 100° C. In a further non-limiting embodiment, the mixture can be heated until a theoretical value for SH content of from 0.5% to 20% is achieved.

The number average molecular weight (Mₙ) of the resulting dithiol oligomer can vary widely. In a non-limiting embodiment, the number average molecular weight (Mₙ) of dithiol oligomer can be determined by the stoichiometry of the reaction. In alternate non-limiting embodiments, the Mₙ of dithiol oligomer can be at least 250 grams/mole, or less than or equal to 3000 grams/mole, or from 250 to 2000 grams/mole, or from 250 to 1500 grams/mole.

In another non-limiting embodiment, the dithiol for use in the present invention can include dithiol oligomer, prepared by reaction of at least one or more dithiol with at least two or more different dienes, wherein the stoichiometric ratio of the sum of the number of equivalents of all dithiols present to the sum of the number of equivalents of all dienes present is greater than 1.0:1.0. As used herein and the claims when referring to the dienes used in this reaction, the term “different dienes” includes the following non-limiting embodiments:

at least one non-cyclic diene and at least one cyclic diene selected from non-aromatic ring-containing dienes including but not limited to non-aromatic monocyclic dienes, non-aromatic polycyclic dienes or combinations thereof, and/or aromatic ring-containing dienes;

at least one aromatic ring-containing diene and at least one diene selected from non-aromatic cyclic dienes described above;

at least one non-aromatic monocyclic diene and at least one non-aromatic polycyclic diene.

In a further non-limiting embodiment, the molar ratio of dithiol to diene in the reaction mixture can be (n+1) to (n) wherein n can represent an integer from 2 to 30.

Suitable dithiols for use in preparing the dithiol oligomer can be selected from a wide variety known in the art. Non-limiting examples can include those described herein.

Further non-limiting examples of suitable dithiols for use in preparing the dithiol oligomer can include but are not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), 2-mercaptoethylsulfide (DMDS), methyl-substituted 2-mercaptoethylsulfide, dimethyl-substituted 2-mercaptoethylsulfide, 1,8-dimercapto-3,6-dioxaoctane and 1,5-dimercapto-3-oxapentane. In alternate non-limiting embodiments, the dithiol can be 2,5-dimercaptomethyl-1,4-dithiane, ethylene glycol di(2-mercaptoacetate), ethylene glycol di(3-mercaptopropionate), poly(ethylene glycol) di(2-mercaptoacetate), poly(ethylene glycol) di(3-mercaptopropionate), dipentene dimercaptan (DPDM), and mixtures thereof.

The at least two or more different dienes can each be independently chosen from non-cyclic dienes, including straight chain and/or branched aliphatic non-cyclic dienes, non-aromatic ring-containing dienes, including non-aromatic ring-containing dienes wherein the double bonds can be contained within the ring or not contained within the ring or any combination thereof, and wherein said non-aromatic ring-containing dienes can contain non-aromatic monocyclic groups or non-aromatic polycyclic groups or combinations thereof; aromatic ring-containing dienes; or heterocyclic ring-containing dienes; or dienes containing any combination of such non-cyclic and/or cyclic groups, and wherein said two or more different dienes can optionally contain thioether, disulfide, polysulfide, sulfone, ester, thioester, carbonate, thiocarbonate, urethane, or thiourethane linkages, or halogen substituents, or combinations thereof; with the proviso that said dienes contain double bonds capable of undergoing reaction with SH groups of polythiol, and forming covalent C—S bonds, and at least two of said dienes are different from one another; and the at least one or more dithiol can each be independently chosen from dithiols containing straight chain and/or branched non-cyclic aliphatic groups, cycloaliphatic groups, aryl groups, aryl-alkyl groups, heterocyclic groups, or combinations or mixtures thereof, and wherein said at least one or more dithiol can each optionally contain thioether, disulfide, polysulfide, sulfone, ester, thioester, carbonate, thiocarbonate, urethane, or thiourethane linkages, or halogen substituents, or combinations thereof; and wherein the stoichiometric ratio of the sum of the number of equivalents of all dithiols present to the sum of the number of equivalents of all dienes present is greater than 1:1. In non-limiting embodiments, said ratio can be within the range of from greater than 1:1 to 3:1, or from 1.01:1 to 3:1, or from 1.01:1 to 2:1, or from 1.05:1 to 2:1, or from 1.1:1 to 1.5:1, or from 1.25:1 to 1.5:1. As used herein and in the claims, the term “number of equivalents” refers to the number of moles of a particular diene or dithiol, multiplied by the average number of thiol groups or double bond groups per molecule of said diene or dithiol, respectively.

The reaction mixture that consists of the group of at least two or more different dienes and the group of at least one or more dithiol and the corresponding number of equivalents of each diene and dithiol that is used to prepare the dithiol oligomer can be depicted as shown in Scheme I below:

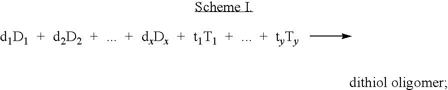

wherein D₁ through Dₓ represent two or more different dienes, x is an integer greater than or equal to 2, that represents the total number of different dienes that are present; d₁ through dₓ represent the number of equivalents of each corresponding diene; T₁ through T_{y} represent one or more dithiol; and t₁ through t_{y} represent the number of equivalents of each corresponding dithiol.

More generally, the group of at least two or more different dienes and the corresponding number of equivalents of each diene can be described by the term dᵢDᵢ (such as d₁D₁ through dₓDₓ, as shown in Scheme I above), wherein Dᵢ represents the i^{th} diene and dᵢ represents the number of equivalents of Dᵢ, i being can be an integer ranging from 1 to x, wherein x is an integer, greater than or equal to 2, that defines the total number of different dienes that are present. Furthermore, the sum of the number of equivalents of all dienes present can be represented by the term d, defined according to Expression (I),

$$d = {\sum }_{i = 1}^{x} {d}_{i} \qquad Expression ( I )$$

wherein i, x, and dᵢ are as defined above.

Similarly, the group of at least one or more dithiol and the corresponding number of equivalents of each dithiol can be described by the term tⱼTⱼ (such as t₁T₁ through t_{y}T_{y}, as shown in Scheme I above), wherein Tⱼ represents the j^{th} dithiol and tⱼ represents the number of equivalents of the corresponding dithiol Tⱼ, j being an integer ranging from 1 to y, wherein y is an integer that defines the total number of dithiols present, and y has a value greater than or equal to 1. Furthermore, the sum of the number of equivalents of all dithiols present can be represented by the term t, defined according to Expression (II),

$$t = {\sum }_{j = 1}^{y} {t}_{j} \qquad Expression ( II )$$

wherein j, y, and tⱼ are as defined above.

The ratio of the sum of the number of equivalents of all dithiols present to the sum of the number of equivalents of all dienes present can be characterized by the term t/d, wherein t and d are as defined above. The ratio t/d is a rational number with values greater than 1:1. In non-limiting embodiments, the ratio t/d can have values within the range of from greater than 1:1 to 3:1, or from 1.01:1 to 3:1, or from 1.01:1 to 2:1, or from 1.05:1 to 2:1, or from 1.1:1 to 1.5:1, or from 1.25:1 to 1.5:1.

As is known in the art, for a given set of dienes and dithiols, a statistical mixture of oligomer molecules with varying molecular weights are formed during the reaction in which the dithiol oligomer is prepared, where the number average molecular weight of the resulting mixture can be calculated and predicted based upon the molecular weights of the dienes and dithiols, and the relative equivalent ratio or mole ratio of the dienes and dithiols present in the reaction mixture that is used to prepare said dithiol oligomer. As is also known to those skilled in the art, the above parameters can be varied in order to adjust the number average molecular weight of the dithiol oligomer. For example, in a non-limiting embodiment, if the value of x as defined above is 2, and the value of y is 1; and diene₁ has a molecular weight (MW) of 120, diene₂ has a molecular weight of 158, dithiol has a molecular weight of 154; and diene₁, diene₂, and dithiol are present in relative molar amounts of 2 moles:4 moles:8 moles, respectively, then the number average molecular weight (Mₙ) of the resulting dithiol oligomer is calculated as follows:

Mₙ={(moles_{diene1}×MW_{diene1})+(moles_{diene2}×MW_{diene2})+(moles_{dithiol}×MW_{dithiol})}/m,

wherein m is the number of moles of the material that is present in the smallest molar amount.

={(2×120)+(4×158)+(8×154)}/2=1052 g/mole

As used herein and in the claims when referring to the group of at least two or more different dienes used in the preparation of the dithiol oligomer, the term “different dienes” refers to dienes that can be different from one another in any one of a variety of ways. In non-limiting embodiments, the “different dienes” can be different from one another in one of the following three ways: a) non-cyclic vs. cyclic; b) aromatic-ring containing vs. non-aromatic; or c) monocyclic non-aromatic vs. polycyclic non-aromatic; whereby non-limiting embodiments of this invention can include any of the following three embodiments:

a) at least one non-cyclic diene and at least one cyclic diene selected from non-aromatic ring-containing dienes, including but not limited to dienes containing non-aromatic monocyclic groups or dienes containing non-aromatic polycyclic groups, or combinations thereof, and/or aromatic ring-containing dienes; or

b) at least one aromatic ring-containing diene and at least one diene selected from non-aromatic cyclic dienes, as described above; or

c) at least one non-aromatic ring containing diene containing non-aromatic monocyclic group, and at least one non-aromatic ring-containing diene containing polycyclic non-aromatic group.

in a non-limiting embodiment, the dithiol oligomer can be as depicted in Formula (AA′) in Scheme II below, produced from the reaction of Diene₁ and Diene₂ with a dithiol; wherein R₂ and R₄ can be independently chosen from H, methyl, or ethyl, and R₁ and R₃ can be independently chosen from straight chain and/or branched aliphatic non-cyclic moieties, non-aromatic ring-containing moieties, including non-aromatic monocyclic moieties or non-aromatic polycyclic moieties or combinations thereof; aromatic ring-containing moieties; or heterocyclic ring-containing moieties; or moieties containing any combination of such non-cyclic and/or cyclic groups, and wherein R₁ and R₃ can optionally contain ether, thioether, disulfide, polysulfide, sulfone, ester, thioester, carbonate, thiocarbonate, urethane, or thiourethane linkages, or halogen substituents, or combinations thereof; with the proviso that Diene₁ and Diene₂ contain double bonds capable of reacting with SH of polythiol, and forming covalent C—S bonds, and Diene₁ and Diene₂ are different from one another; and wherein R₅ can be chosen from divalent groups containing straight chain and/or branched non-cyclic aliphatic groups, cycloaliphatic groups, aryl groups, aryl-alkyl groups, heterocyclic groups, or combinations or mixtures thereof, and wherein R₅ can optionally contain ether, thioether, disulfide, polysulfide, sulfone, ester, thioester, carbonate, thiocarbonate, urethane, or thiourethane linkages, or halogen substituents, or combinations thereof; and n is an integer ranging from 1 to 20.

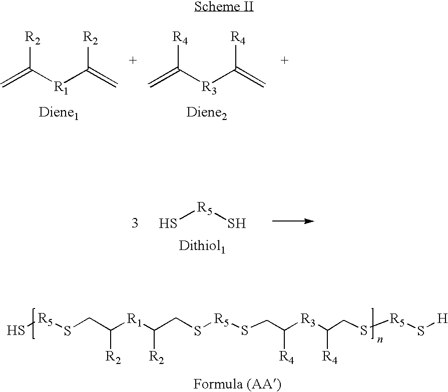

In a second non-limiting embodiment, the dithiol oligomer can be as depicted in Formula (AA″) in Scheme III below, produced from the reaction of Diene, and 4-vinyl-1-norbornene (VNB) with a dithiol; wherein R₂ can be chosen from H, methyl, or ethyl, and R₁ can be chosen from straight chain and/or branched aliphatic non-cyclic moieties, non-aromatic ring-containing moieties, wherein said non-aromatic ring-containing moieties can include non-aromatic monocyclic moieties; aromatic ring-containing moieties; or heterocyclic ring-containing moieties; or include moieties containing any combination of such non-cyclic and/or cyclic groups, and wherein R₁ can optionally contain ether, thioether, disulfide, polysulfide, sulfone, ester, thioester, carbonate, thiocarbonate, urethane, or thiourethane linkages, or halogen substituents, or combinations thereof; with the proviso that Diene₁ contains double bonds capable of reacting with SH of polythiol, and forming covalent C—S bonds, and Diene, is different from VNB; and wherein R₃ can be chosen from divalent groups containing straight chain and/or branched non-cyclic aliphatic groups, cycloaliphatic groups, aryl groups, aryl-alkyl groups, heterocyclic groups, or combinations or mixtures thereof, and wherein R₃ can optionally contain ether, thioether, disulfide, polysulfide, sulfone, ester, thioester, carbonate, thiocarbonate, urethane, or thiourethane linkages, or halogen substituents, or combinations thereof; and n is an integer ranging from 1 to 20.

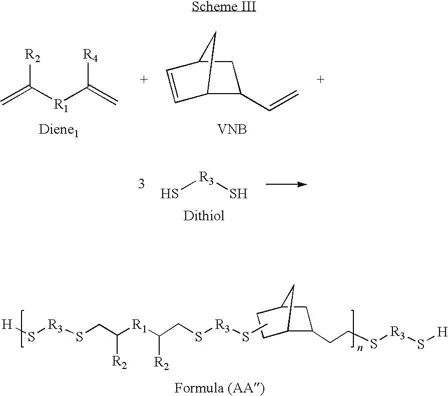

In a third non-limiting embodiment, wherein the dithiol oligomer comprises dithiol oligomer depicted in Formula (AA′″) in Scheme IV below, produced from the reaction of Diene₁ and 4-vinyl-1-cyclohexene (VCH) with a dithiol; wherein R₂ can be chosen from H, methyl, or ethyl, and R₁ can be chosen from straight chain and/or branched aliphatic non-cyclic moieties, non-aromatic ring-containing moieties, wherein said non-aromatic ring-containing moieties can include non-aromatic polycyclic moieties; aromatic ring-containing moieties; or heterocyclic ring-containing moieties; or moieties containing any combination of such non-cyclic and/or cyclic groups, and wherein R₁ can optionally contain ether, thioether, disulfide, polysulfide, sulfone, ester, thioester, carbonate, thiocarbonate, urethane, or thiourethane linkages, or halogen substituents, or combinations thereof; with the proviso that Diene, contains double bonds capable of reacting with SH of polythiol, and forming covalent C—S bonds, and Diene, is different from VCH; and wherein R₃ can be chosen from divalent groups containing straight chain and/or branched non-cyclic aliphatic groups, cycloaliphatic groups, aryl groups, aryl-alkyl groups, heterocyclic groups, or combinations or mixtures thereof, and wherein R₅ can optionally contain thioether, disulfide, polysulfide, sulfone, ester, thioester, carbonate, thiocarbonate, urethane, or thiourethane linkages, or halogen substituents, or combinations thereof; and n is an integer ranging from 1 to 20.

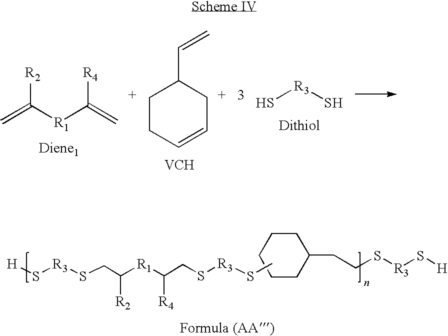

In a further non-limiting embodiment, the polythiol for use in the present invention can comprise polythiol oligomer produced by the reaction of

a) at least two or more different dienes;

b) at least one or more dithiol; and

c) optionally one or more trifunctional or higher functional polythiol;

wherein the at least two or more different dienes can each be independently chosen from non-cyclic dienes, including straight chain and/or branched aliphatic non-cyclic dienes, non-aromatic ring-containing dienes, including non-aromatic ring-containing dienes wherein the double bonds can be contained within the ring or not contained within the ring or any combination thereof, and wherein said non-aromatic ring-containing dienes can contain non-aromatic monocyclic groups or non-aromatic polycyclic groups or combinations thereof; aromatic ring-containing dienes; or heterocyclic ring-containing dienes; or dienes containing any combination of such non-cyclic and/or cyclic groups, and wherein said two or more different dienes can optionally contain thioether, disulfide, polysulfide, sulfone, ester, thioester, carbonate, thiocarbonate, urethane, or thiourethane linkages, or halogen substituents, or combinations thereof; with the proviso that at least two of said dienes contain double bonds capable of reacting with SH group of polythiol, and forming covalent C—S bonds, and at least two or more of said dienes are different from one another; the one or more dithiol can each be independently chosen from dithiols containing straight chain and/or branched non-cyclic aliphatic groups, cycloaliphatic groups, aryl groups, aryl-alkyl groups, heterocyclic groups, or combinations or mixtures thereof, and wherein said one or more dithiol can each optionally contain thioether, disulfide, polysulfide, sulfone, ester, thioester, carbonate, thiocarbonate, urethane, or thiourethane linkages, or halogen substituents, or combinations thereof; the trifunctional or higher functional polythiol can be chosen from polythiols containing straight chain and/or branched non-cyclic aliphatic groups, cycloaliphatic groups, aryl groups, aryl-alkyl groups, heterocyclic groups, or combinations or mixtures thereof, and wherein said trifunctional or higher functional polythiol can each optionally contain thioether, disulfide, polysulfide, sulfone, ester, thioester, carbonate, thiocarbonate, urethane, or thiourethane linkages, or halogen substituents, or combinations thereof; and wherein the stoichiometric ratio of the sum of the number of equivalents of all dithiols present to the sum of the number of equivalents of all dienes present is greater than 1:1.

Suitable dithiols for use in preparing polythiol oligomer can be selected from a wide variety known in the art. Non-limiting examples can include those disclosed herein.

Suitable trifunctional or higher-functional polythiols for use in preparing polythiol oligomer can be selected from a wide variety known in the art. Non-limiting examples can include those disclosed herein. Further non-limiting examples of suitable trifunctional or higher-functional polythiols can include but are not limited to pentaerythritol tetrakis(2-mercaptoacetate), pentaerythritol tetrakis(3-mercaptopropionate), trimethylolpropane tris(2-mercaptoacetate), trimethylolpropane tris(3-mercaptopropionate), thioglycerol bis(2-mercaptoacetate), and mixtures thereof.

Suitable dienes for use in preparing the dithiol oligomer can vary widely and can be selected from those known in the art. Non-limiting examples of suitable dienes can include but are not limited to non-cyclic dienes such as acyclic non-conjugated dienes, acyclic polyvinyl ethers, allyl- and vinyl-acrylates, allyl- and vinyl-methacrylates, diacrylate and dimethacrylate esters of linear diols and dithiols, diacrylate and dimethacrylate esters of poly(alkyleneglycol) diols; monocyclic non-aromatic dienes; polycyclic non-aromatic dienes; aromatic ring-containing dienes such as diallyl and divinyl esters of aromatic ring dicarboxylic acids; and mixtures thereof.

Non-limiting examples of acyclic non-conjugated dienes can include those represented by the following general formula:

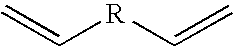

wherein R can represent C₁ to C₃₀ linear branched divalent saturated alkylene radical, or C₂ to C₃₀ divalent organic radical including groups such as but not limited to those containing either, thioether, ester, thioester, ketone, polysulfide, sulfone and combinations thereof. In a non-limiting embodiment, provide fall back position for “R” definition.

In alternate non-limiting embodiments, the acyclic non-conjugated dienes can be selected from 1,5-hexadiene, 1,6-heptadiene, 1,7-octadiene and mixtures thereof.

Non-limiting examples of suitable acyclic polyvinyl ethers can include but are not limited to those represented by structural formula (V′):

CH₂═CH—O—(—R²—O—)ₘ—CH═CH₂ (V′)

wherein R² can be C₂ to C₆ n-alkylene, C₂ to C₆ branched alkylene group, or —[(CH₂—)ₚ—O—]_{q}—(—CH₂—)ᵣ—, m can be a rational number from 0 to 10, p can be an integer from 2 to 6, q can be an integer from 1 to 5 and r can be an integer from 2 to 10.

In a non-limiting embodiment, m can be two (2).

Non-limiting examples of suitable polyvinyl ether monomers for use can include divinyl ether monomers, such as but not limited to ethylene glycol divinyl ether, diethylene glycol divinyl ether, triethyleneglycol divinyl ether, and mixtures thereof.

Non-limiting examples of suitable allyl- and vinyl-acrylates and methacrylates can include but are not limited to those represented by the following formulas:

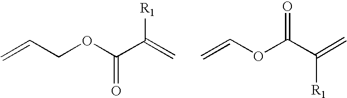

wherein R¹ each independently can be hydrogen or methyl.

In a non-limiting embodiment, the acrylate and methacrylate monomers can include monomers such as but not limited to allyl methacrylate, allyl acrylate and mixtures thereof.

Non-limiting examples of diacrylate and dimethacrylate esters of linear diols can include but are not limited to those represented by the following structural formula:

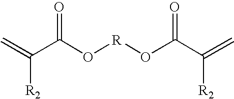

wherein R can represent C₁ to C₃₀ divalent saturated alkylene radical; branched divalent saturated alkylene radical; or C₂ to C₃₀ divalent organic radical including groups such as but not limited to those containing either, thioether, ester, thioester, ketone, polysulfide, sulfone and combinations thereof; and R₂ can represent hydrogen or methyl.

In alternate non-limiting embodiments, the diacrylate and dimethacrylate esters of linear diols can include ethanediol dimethacrylate, 1,3-propanediol diacrylate, 1,3-propanediol dimethacrylate, 1,2-propanediol diacrylate, 1,2-propanediol dimethacrylate, 1,4-butanediol diacrylate, 1,4-butanediol dimethacrylate, 1,3-butanediol diacrylate, 1,3-butanediol dimethacrylate, 1,2-butanediol diacrylate, 1,2-butanediol dimethacrylate, and mixtures thereof.

Non-limiting examples of diacrylate and dimethacrylate esters of poly(alkyleneglycol)diols can include but are not limited to those represented by the following structural formula:

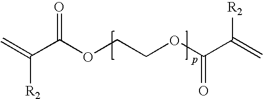

wherein R₂ each independently can represent hydrogen or methyl and p can represent an integer from 1 to 5.

In alternate non-limiting embodiments, the diacrylate and dimethacrylate esters of poly(alkyleneglycol) diols can include ethylene glycol dimethacrylate, ethylene glycol diacrylate, diethylene glycol dimethacrylate, diethylene glycol diacrylate, and mixtures thereof.

Further non-limiting examples of suitable dienes can include monocyclic aliphatic dienes such as but not limited to those represented by the following structural formulas:

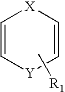

wherein X and Y each independently can represent C₁₋₁₀ divalent saturated alkylene radical; or C₁₋₅ divalent saturated alkylene radical, containing at least one element selected from the group of sulfur, oxygen and silicon in addition to the carbon and hydrogen atoms; and R₁ can represent H, or C₁-C₁₀ alkyl; and

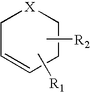

wherein X and R₁ can be as defined above and R₂ can represent C₂-C₁₀ alkenyl.

In alternate non-limiting embodiments, the monocyclic aliphatic dienes can include 1,4-cyclohexadiene, 4-vinyl-1-cyclohexene, dipentene and terpinene.

Non-limiting examples of polycyclic aliphatic dienes can include but are not limited to 5-vinyl-2-norbornene; 2,5-norbornadiene; dicyclopentadiene and mixtures thereof.

Non-limiting examples of aromatic ring-containing dienes can include but are not limited to those represented by the following structural formula:

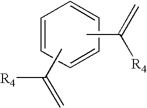

wherein R₄ can represent hydrogen or methyl

In alternate non-limiting embodiments, the aromatic ring-containing dienes can include monomers such as 1,3-diispropenyl benzene, divinyl benzene and mixtures thereof.

Non-limiting examples of diallyl esters of aromatic ring dicarboxylic acids can include but are not limited to those represented by the following structural formula:

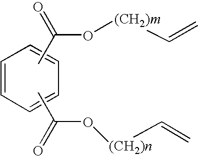

wherein m and n each independently can be an integer from 0 to 5.

In alternate non-limiting embodiments, the diallyl esters of aromatic ring dicarboxylic acids can include o-diallyl phthalate, m-diallyl phthalate, p-diallyl phthalate and mixtures thereof.

In a non-limiting embodiment, reaction of at least one polythiol with two or more different dienes can be carried out in the presence of radical initiator. Suitable radical initiators for use in the present invention can vary widely and can include those known to one of ordinary skill in the art. Non-limiting examples of radical initiators can include but are not limited to azo or peroxide type free-radical initiators such as azobisalkalenenitriles. In a non-limiting embodiment, the free-radical initiator can be azobisalkalenenitrile which is commercially available from DuPont under the trade name VAZO™. In alternate non-limiting embodiments, VAZO-52, VAZO-64, VAZO-67, VAZO-88 and mixtures thereof can be used as radical initiators.

In a non limiting embodiment, selection of the free-radical initiator can depend on reaction temperature. In a non-limiting embodiment, the reaction temperature can vary from room temperature to 100° C. In further alternate non-limiting embodiments, Vazo 52 can be used at a temperature of from 50-60° C., or Vazo 64, Vazo 67 can be used at a temperature of 60-70° C., or and Vazo 88 can be used at a temperature of 70-100° C.

The reaction of at least one polythiol and two or more different dienes can be carried out under a variety of reaction conditions. In alternate non-limiting embodiments, such conditions can depend on the degree of reactivity of the dienes and the desired structure of the resulting polythiol oligomer. In a non-limiting embodiment, polythiol, two or more different dienes and radical initiator can be combined together while heating the mixture. In a further non-limiting embodiment, polythiol and radical initiator can be combined together and added in relatively small amounts over a period of time to a mixture of two or more dienes. In another non-limiting embodiment, two or more dienes can be combined with polythiol in a stepwise manner under radical initiation.

In another non-limiting embodiment, polythiol can be mixed with one diene and optionally free radical initiator; the diene and polythiol and optionally free radical initiator can be allowed to react and then a second diene can be added to the mixture, followed by addition of the radical initiator to the mixture. The mixture is allowed to react until the double bonds are essentially consumed and a pre-calculated (e.g., by titration based on stoichiometry) theoretical SH equivalent weight is obtained. The reaction time for completion can vary from one hour to five days depending on the reactivity of the dienes used.

In a further non-limiting embodiment, the final oligomeric product of the stepwise addition process can be a block-type copolymer.

In a non-limiting embodiment, the reaction of at least one polythiol with two or more different dienes can be carried out in the presence of a catalyst. Suitable catalysts for use in the reaction can vary widely and can be selected from those known in the art. The amount of catalyst used in the reaction of the present invention can vary widely and can depend on the catalyst selected. In a non-limiting embodiment, the amount of catalyst can be present in an amount of from 0.01% by weight to 5% by weight of the reaction mixture.

In a non-limiting embodiment, wherein the mixture of dienes can be a mixture of acrylic monomers, the acrylic monomers can be reacted with polythiol in the presence of a base catalyst. Suitable base catalysts for use in this reaction vary widely and can be selected from those known in the art. Non-limiting examples can include but are not limited to tertiary amine bases such as 1,8-diazabicyclo[5.4.0]undec-7-ene (DBU) and N,N-dimethylbenzylamine. The amount of base catalyst used can vary widely. In a non-limiting embodiment, the base catalyst can be present in an amount of from 0.01 to 5.0% by weight of the reaction mixture. The reaction of the acrylic monomers with polythiol in the presence of a base catalyst can substantially minimize or essentially preclude double bond polymerization.

In another non-limiting embodiment, in order to substantially minimize or essentially preclude double bond polymerization, acrylic double bonds can be first reacted with polythiol under basic catalysis conditions and then, electron-rich reactive double bond dienes can be added to the intermediate product and reacted under radical initiation conditions. Non-limiting examples of electron-rich reactive double bond dienes can include materials such as but not limited to vinyl ethers, aliphatic dienes and cycloaliphatic dienes.

Not intending to be bound by any particular theory, it is believed that as the mixture of polythiol, dienes and radical intiator is heated, the double bonds are at least partially consumed by reaction with the SH groups of the polythiol. The mixture can be heated for a sufficient period of time such that the double bonds are essentially consumed and a pre-calculated theoretical value for SH content is reached. In a non-limiting embodiment, the mixture can be heated for a time period of from 1 hour to 5 days. In another non-limiting embodiment, the mixture can be heated at a temperature of from 40° C. to 100° C. In a further non-limiting embodiment, the mixture can be heated until a theoretical value for SH content of from 0.7% to 17% is reached.

The number average molecular weight (Mₙ) of the resulting polythiol oligomer can vary widely. The number average molecular weight (Mₙ) of polythiol oligomer can be predicted based on the stoichiometry of the reaction. In alternate non-limiting embodiments, the Mₙ of polythiol oligomer can vary from 400 to 3,000 grams/mole, or from 400 to 2000 grams/mole, or from 400 to 1500 grams/mole.

The viscosity of the resulting polythiol oligomer can vary widely. In alternate non-limiting embodiments, the viscosity can be from 40 cP to 4000 cP at 73° C., or from 40 cP to 2000 cP at 73° C., or from 150 cP to 1500 cP at 73° C.

In a non limiting embodiment, vinylcyclohexene (VCH) and 1,5-hexadiene (1,5-HD) can be combined together, and 2-mercaptoethylsulfide (DMDS) and a radical initiator (such as Vazo 52) can be mixed together, and this mixture can be added dropwise to the mixture of dienes at a rate such that a temperature of 60° C. is not exceeded. After the addition is completed, the mixture can be heated to maintain a temperature of 60° C. until the double bonds are essentially consumed and the pre-calculated theoretical value for SH content is reached.

In alternate non-limiting embodiments, dithiol oligomer can be prepared from the following combinations of dienes and dithiol:
(a) 5-vinyl-2-norbornene (VNB), diethylene glycol divinyl ether (DEGDVE) and DMDS;
(b) 1,3-diisopropenylbenzene (DIPEB), DEGDVE and DMDS;
(c) DIPEB, VNB and DMDS;
(d) DIPEB, 4-Vinyl-1-cyclohexene (VCH), DMDS;
(e) allylmethacrylate (AM), VNB and DMDS;
(f) VCH, VNB, and DMDS;
(g) limonene(L), VNB and DMDS; and
(h) ethylene glycol dimethacrylate (EGDM), VCH and DMDS.

The nature of the SH group of polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a mechanism for the oxidative coupling of thiol groups may involve the formation of thiyl radicals, followed by coupling of said thiyl radicals, to form disulfide linkage. It is further believed that formation of disulfide linkage may occur under conditions that can lead to formation of thiyl radical, including but not limited to reaction conditions involving free radical initiation.

In a non-limiting embodiment, the polythiol oligomer for use in the present invention can contain disulfide linkages present in the polythiols used to prepare said polythiol oligomer. In another non-limiting embodiment, the polythiol oligomer for use in the present invention can contain disulfide linkage formed during the synthesis of said polythiol oligomer. In another non-limiting embodiment, the polythiol oligomer for use in the present invention can contain disulfide linkages formed during storage of said polythiol oligomer in the presence of air.

Non-limiting examples of suitable active hydrogen-containing materials having both hydroxyl and thiol groups can include but are not limited to 2-mercaptoethanol, 3-mercapto-1,2-propanediol, glycerin bis(2-mercaptoacetate), glycerin bis(3-mercaptopropionate), 1-hydroxy-4-mercaptocyclohexane, 1,3-dimercapto-2-propanol, 2,3-dimercapto-1-propanol, trimethylolpropane bis(2-mercaptoacetate), trimethylolpropane bis(3-mercaptopropionate), pentaerythritol mono(2-mercaptoacetate), pentaerythritol bis(2-mercaptoacetate), pentaerythritol tris(2-mercaptoacetate), pentaerythritol mono(3-mercaptopropionate), pentaerythritol bis(3-mercaptopropionate), pentaerythritol tris(3-mercaptopropionate), dihydroxyethyl sulfide mono(3-mercaptopropionate), and mixtures thereof.

In a non-limiting embodiment, said polyurethane prepolymer or sulfur-containing polyurethane prepolymer of the present invention can contain disulfide linkages due to disulfide linkages contained in the polythiol and/or polythiol oligomer used to prepare said prepolymer.

In a non-limiting embodiment, polyurethane or sulfur-containing polyurethane of the present invention can be prepared by reacting polyisocyanate and/or polyisothiocyanate with at least one material selected from tri-functional or higher-functional polyol and/or polythiol, and/or polyfunctional material containing both hydroxyl and SH groups, to form polyurethane prepolymer or sulfur-containing polyurethane prepolymer; and chain extending said prepolymer with active hydrogen-containing material, wherein said active hydrogen-containing material can include diol and/or dithiol and/or difunctional material containing both hydroxyl and SH groups, and optionally trifunctional or higher-functional polyol and/or polythiol and/or polyfunctional material containing both hydroxyl and SH groups.

In another non-limiting embodiment, polyurethane or sulfur-containing polyurethane of the present invention can be prepared by reacting (a) polyisocyanate and/or polyisothiocyanate; (b) tri-functional or higher-functional polyol and/or polythiol and/or polyfunctional material containing both hydroxyl and SH groups; and (c) diol and/or dithiol and/or difunctional material containing both hydroxyl and SH groups; in a one-pot process.

The polyurethane and/or sulfur-containing polyurethane of the present invention can be prepared using a variety of techniques known in the art. In a non-limiting embodiment, the polyurethane and/or sulfur-containing polyurethane can be prepared by introducing together polyisocyanate, polyisothiocyanate or a mixture thereof and trifunctional or higher functional polyol or polythiol or polyfunctional material containing both hydroxyl and SH groups, or mixtures thereof and allowing them to react to form polyurethane prepolymer and/or sulfur-containing polyurethane prepolymer, and then introducing active hydrogen-containing material, wherein said active hydrogen-containing material can include diol and/or dithiol and/or difunctional material containing both hydroxyl and SH groups, and optionally trifunctional or higher-functional polyol and/or polythiol and/or polyfunctional material containing both hydroxyl and SH groups, and optionally catalyst, and carrying out polymerization to form polyurethane and/or sulfur-containing polyurethane. In a non-limiting embodiment, each of the aforementioned ingredients each can be degassed prior to combining them. In another non-limiting embodiment, the prepolymer can be degassed, the remaining materials can be mixed together and degassed, and then the prepolymer and active hydrogen-containing material, and optionally catalyst, can be combined and allowed to react.

In another non-limiting embodiment, the polyurethane and/or sulfur-containing polyurethane of the present invention can be prepared by a one-pot process; the polyurethane and/or sulfur-containing polyurethane can be prepared by introducing together the polyisocyanate and/or polyisothiocyanate; trifunctional or higher functional polyol and/or polythiol and/or polyfunctional material containing both hydroxyl and SH groups; and diol and/or dithiol and/or difunctional material containing both hydroxyl and SH groups; and optionally catalyst; and carrying out polymerization to form said polyurethane and/or sulfur-containing polyurethane. In a non-limiting embodiment, each of the aforementioned ingredients each can be degassed prior to combining them.

Suitable catalysts can be selected from those known in the art. Non-limiting examples can include but are not limited to tertiary amine catalysts or tin compounds or mixtures thereof. In alternate non-limiting embodiments, the catalysts can be dimethyl cyclohexylamine or dibutyl tin dilaurate or mixtures thereof. In further non-limiting embodiments, degassing can take place prior to or following addition of catalyst.

In another non-limiting embodiment, wherein a lens can be formed, the mixture which can be optionally degassed can be introduced into a mold and the mold can be heated (i.e., thermal cure cycle) using a variety of conventional techniques known in the art. The thermal cure cycle can vary depending on the reactivity and molar ratio of the reactants. In a non-limiting embodiment, the thermal cure cycle can include heating the mixture of prepolymer, and dithiol and/or diol; or heating the mixture of polyisocyanate and/or polyisothiocyanate, polyol and/or polythiol, and dithiol and/or diol, from room temperature to a temperature of 200° C. over a period of from 0.5 hours to 120 hours; or from 80 to 10SC for a period of from 5 hours to 48 hours.

In a non-limiting embodiment, a urethanation catalyst can be used in the present invention to enhance the reaction of the polyurethane-forming materials. Suitable urethanation catalysts can vary, for example, suitable urethanation catalysts can include those catalysts that are useful for the formation of urethane by reaction of the NCO and OH-containing materials and/or NCO and SH-containing materials. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In a non-limiting embodiment, the catalyst can be a stannous salt of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, 1,4-diazabicyclo[2.2.2]octane, and mixtures thereof. In alternate non-limiting embodiments, the catalyst can be zinc octoate, bismuth, or ferric acetylacetonate.

Further non-limiting examples of suitable catalysts can include tin compounds such as but not limited to dibutyl tin dilaurate, phosphines, tertiary ammonium salts and tertiary amines such as but not limited to triethylamine, triisopropylamine, dimethyl cyclohexylamine, N,N-dimethylbenzylamine and mixtures thereof. Such suitable tertiary amines are disclosed in U.S. Pat. No. 5,693,738 at column 10, lines 6-38, the disclosure of which is incorporated herein by reference.

In alternate non-limiting embodiments, various known additives can be incorporated into the polyurethane and/or sulfur containing polyurethane of the present invention. Such additives can include but are not limited to light stabilizers, heat stabilizers, antioxidants, ultraviolet light absorbers, mold release agents, static (non-photochromic) dyes, pigments and flexibilizing additives, such as but not limited to alkoxylated phenol benzoates and poly(alkylene glycol) dibenzoates. Non-limiting examples of anti-yellowing additives can include 3-methyl-2-butenol, organo pyrocarbonates and triphenyl phosphite (CAS registry no. 101-02-0). Such additives can be present in an amount such that the additive constitutes less than 10 percent by weight, or less than 5 percent by weight, or less than 3 percent by weight, based on the total weight of the prepolymer. In alternate non-limiting embodiments, the aforementioned optional additives can be mixed with the polyisocyanate and/or polyisocyanate. In a further embodiment, the optional additives can be mixed with active hydrogen-containing material.

In a non-limiting embodiment, the polymerizable composition of the present invention can be subjected to curing conditions (such as thermal curing, for example) until it is at least partially cured. In non-limiting embodiments, the term “at least partially cured,” can mean subjecting the polymerizable composition to curing conditions, wherein reaction of at least a portion of the reactive end-groups of said composition occurs, to form a solid polymerizate, such that said polymerizate can be demolded, and cut into test pieces, or such that it can be subjected to machining operations, including optical lens processing, or such that it is suitable for optical or ophthalmic lens applications.

In an alternate non-limiting embodiment, the polymerizable composition can be subjected to curing conditions (such as thermal curing, for example), such that a state of substantially complete cure is attained, wherein further curing under the same conditions results in no significant further improvement of polymer properties, such as hardness.

In a non-limiting embodiment, the resulting polyurethane and sulfur-containing polyurethane of the present invention when cured can be solid, and essentially transparent such that it is suitable for optical or ophthalmic lens applications. In alternate non-limiting embodiments, the polyurethane and sulfur-containing polyurethane can have a refractive index of at least 1.50, or at least 1.53, or at least 1.55, or at least 1.56, or at least 1.57, or at least 1.58, or at least 1.59, or at least 1.60, or at least 1.62, or at least 1.65. In further alternate non-limiting embodiments, the polyurethane and/or sulfur-containing polyurethane when cured can have an Abbe number of at least 30, or at least 32, or at least 35, or at least 38, or at least 39, or at least 40, or at least 44.

In non-limiting embodiments, the polyurethane and/or sulfur-containing polyurethane when cured can have adequately high hardness. In a non-limiting embodiment, hardness can be measured in accordance with ISO standard test method BS EN ISO 14577-1:2002, using a Fischer Scope H-100 instrument, supplied by Fischer Technology, Inc., and reported as Martens Hardness, in the units of Newtons (N)/mm².

In a non-limiting embodiment, the polyurethane or sulfur-containing polyurethane of the present invention when cured can have Martens Hardness (HM 0.3/15/0) of greater than 80, or greater than 100, or greater than 110, or greater than 120, or greater than 130 Newton/mm²; or less than 220, or less than 200 Newton/mm².

In non-limiting embodiments, the polyurethane and/or sulfur-containing polyurethane when cured can have adequately high thermal properties. In a non-limiting embodiment, thermal properties can be measured in accordance with ASTM D648 Method B, using an HDT Vicat instrument, supplied by CEAST USA, Inc Further, in a non-limiting embodiment, thermal properties of a polymerizate can be reported as Heat Distortion Temperature (i.e., temperature at which 0.254 mm (10 mils) deflection occurs).

In a non-limiting embodiment, the polyurethane or sulfur-containing polyurethane of the present invention when cured can have Heat Distortion Temperature of at least 80° C., or at least 90° C., or at least 100° C. or at least 110° C.

In a non-limiting embodiment, the polyurethane and/or sulfur-containing polyurethane when cured can demonstrate good impact resistance/strength. Impact resistance can be measured using a variety of conventional methods known to one skilled in the art.

In a non-limiting embodiment, the polyurethane and/or sulfur-containing polyurethane when cured can have good impact resistance/strength. Impact resistance can be measured using a variety of conventional methods known to one skilled in the art.

In a non-limiting embodiment, the impact resistance can be measured using the Impact Energy Test as previously described herein.

In a non-limiting embodiment, the polyurethane and/or sulfur-containing polyurethane of the present invention when cured can have low density. In non-limiting embodiments, the density can be from 1.0 to less than 1.3 grams/cm³ or from 1.0 to less than 1.4 grams/cm³, or from 1.0 to less than 1.45 grams/cm³, or from 1.1 to less than 1.45 grams/cm³, or from 1.1 to less than 1.4 grams/cm³, or from 1.1 to less than 1.3 grams/cm³. In a non-limiting embodiment, the density is measured using a DensiTECH instrument manufactured by Tech Pro, Incorporated. In a further non-limiting embodiment, the density is measured in accordance with ASTM D297.

Solid articles that can be prepared using the polyurethane and/or sulfur-containing polyurethane polymerizate of the present invention include but are not limited to optical lenses, such as plano and ophthalmic lenses, sun lenses, windows, automotive transparencies, such as windshields, sidelights and backlights, and aircraft transparencies.

In a non-limiting embodiment, the polyurethane and/or sulfur-containing polyurethane polymerizate of the present invention can be used to prepare photochromic articles, such as lenses. In a further embodiment, the polymerizate can be transparent to that portion of the electromagnetic spectrum which activates the photochromic substances), i.e., that wavelength of ultraviolet (UV) light that produces the colored or open form of the photochromic substance and that portion of the visible spectrum that includes the absorption maximum wavelength of the photochromic substance in its UV activated form, i.e., the open form.

A wide variety of photochromic substances can be used in the present invention. In a non-limiting embodiment, organic photochromic compounds or substances can be used. In alternate non-limiting embodiments, the photochromic substance can be incorporated, e.g., dissolved, dispersed or diffused into the polymerizate, or applied as a coating thereto.

In a non-limiting embodiment, the organic photochromic substance can have an activated absorption maximum within the visible range of greater than 590 nanometers. In a further non-limiting embodiment, the activated absorption maximum within the visible range can be between greater than 590 to 700 nanometers. These materials can exhibit a blue, bluish-green, or bluish-purple color when exposed to ultraviolet light in an appropriate solvent or matrix. Non-limiting examples of such substances that are useful in the present invention include but are not limited to spiro(indoline)naphthoxazines and spiro(indoline)benzoxazines. These and other suitable photochromic substances are described in U.S. Pat. Nos.: 3,562,172; 3,578,602; 4,215,010; 4,342,668; 5,405,958; 4,637,698; 4,931,219; 4,816,584; 4,880,667; 4,818,096.

In another non-limiting embodiment, the organic photochromic substances can have at least one absorption maximum within the visible range of between 400 and less than 500 nanometers. In a further non-limiting embodiment, the substance can have two absorption maxima within this visible range. These materials can exhibit a yellow-orange color when exposed to ultraviolet light in an appropriate solvent or matrix. Non-limiting examples of such materials can include certain chromenes, such as but not limited to benzopyrans and naphthopyrans. Many of such chromenes are described in U.S. Pat. Nos. 3,567,605; 4,826,977; 5,066,818; 4,826,977; 5,066,818; 5,466,398; 5,384,077; 5,238,931; and 5,274,132.

In another non-limiting embodiment, the photochromic substance can have an absorption maximum within the visible range of between 400 to 500 nanometers and an absorption maximum within the visible range of between 500 to 700 nanometers. These materials can exhibit color(s) ranging from yellow/brown to purple/gray when exposed to ultraviolet light in an appropriate solvent or matrix. Non-limiting examples of these substances can include certain benzopyran compounds having substituents at the 2-position of the pyran ring and a substituted or unsubstituted heterocyclic ring, such as a benzothieno or benzofurano ring fused to the benzene portion of the benzopyran. Further non-limiting examples of such materials are disclosed in U.S. Pat. No. 5,429,774.

In a non-limiting embodiment, the photochromic substance for use in the present invention can include photochromic organo-metal dithizonates, such as but not limited to (arylazo)-thioformic arylhydrazidates, such as but not limited to mercury dithizonates which are described, for example, in U.S. Pat. No. 3,361,706. Fulgides and fulgimides, such as but not limited to 3-furyl and 3-thienyl fulgides and fulgimides which are described in U.S. Pat. No. 4,931,220 at column 20, line 5 through column 21, line 38, can be used in the present invention.

The relevant portions of the aforedescribed patents are incorporated herein by reference.

In alternate non-limiting embodiments, the photochromic articles of the present invention can include one photochromic substance or a mixture of more than one photochromic substances. In further alternate non-limiting embodiment, various mixtures of photochromic substances can be used to attain activated colors such as a near neutral gray or brown.

The amount of photochromic substance employed can vary. In alternate non-limiting embodiments, the amount of photochromic substance and the ratio of substances (for example, when mixtures are used) can be such that the polymerizate to which the substance is applied or in which it is incorporated exhibits a desired resultant color, e.g., a substantially neutral color such as shades of gray or brown when activated with unfiltered sunlight, i.e., as near a neutral color as possible given the colors of the activated photochromic substances. In a non-limiting embodiment, the amount of photochromic substance used can depend upon the intensity of the color of the activated species and the ultimate color desired.

In alternate non-limiting embodiments, the photochromic substance can be applied to or incorporated into the polymerizate by various methods known in the art. In a non-limiting embodiment, the photochromic substance can be dissolved or dispersed within the polymerizate. In a further non-limiting embodiment, the photochromic substance can be imbibed into the polymerizate by methods known in the art. The term “imbibition” or “imbibe” includes permeation of the photochromic substance alone into the polymerizate, solvent assisted transfer absorption of the photochromic substance into a porous polymer, vapor phase transfer, and other such transfer mechanisms. In a non-limiting embodiment, the imbibing method can include coating the photochromic article with the photochromic substance; heating the surface of the photochromic article; and removing the residual coating from the surface of the photochromic article. In alternate non-limiting embodiments, the imbibtion process can include immersing the polymerizate in a hot solution of the photochromic substance or by thermal transfer.

In alternate non-limiting embodiments, the photochromic substance can be a separate layer between adjacent layers of the polymerizate, e.g., as a part of a polymer film; or the photochromic substance can be applied as a coating or as part of a coating placed on the surface of the polymerizate.

The amount of photochromic substance or composition containing the same applied to or incorporated into the polymerizate can vary. In a non-limiting embodiment, the amount can be such that a photochromic effect discernible to the naked eye upon activation is produced. Such an amount can be described in general as a photochromic amount. In alternate non-limiting embodiments, the amount used can depend upon the intensity of color desired upon irradiation thereof and the method used to incorporate or apply the photochromic substance. In general, the more photochromic substance applied or incorporated, the greater the color intensity. In a non-limiting embodiment, the amount of photochromic substance incorporated into or applied onto a photochromic optical polymerizate can be from 0.15 to 0.35 milligrams per square centimeter of surface to which the photochromic substance is incorporated or applied.

In another embodiment, the photochromic substance can be added to the, polyurethane and sulfur-containing polyurethane prior to polymerizing and/or cast curing the material. In this embodiment, the photochromic substance used can be chosen such that it is resistant to potentially adverse interactions with, for example, the isocyanate, isothiocyante and amine groups present. Such adverse interactions can result in deactivation of the photochromic substance, for example, by trapping them in either an open or closed form.

Further non-limiting examples of suitable photochromic substances for use in the present invention can include photochromic pigments and organic photochromic substances encapsulated in metal oxides such as those disclosed in U.S. Pat. Nos. 4,166,043 and 4,367,170; organic photochromic substances encapsulated in an organic polymerizate such as those disclosed in U.S. Pat. No. 4,931,220.

### EXAMPLES

### Experimental Methods for Characterizing Compositions and Properties

In the following examples, unless otherwise stated, the refractive index and Abbe number were measured on a multiple wavelength Abbe Refractometer Model DR-M2 manufactured by ATAGO Co., Ltd.; the refractive index and Abbe number of liquids were measured in accordance with ASTM-D1218; the refractive index and Abbe number of solids was measured in accordance with ASTM-D-542.

The density of solids was measured in accordance with ASTM-D792.

The viscosity was measured using a Brookfield CAP 2000+Viscometer.

Percent Haze was measured in accordance with ASTM-D1003, using a Color Quest XE instrument, manufactured by Hunter Associates Laboratory, Inc.

Hardness was measured in accordance with ISO standard test method BS EN ISO 14577-1:2002, using a Fischer Scope H-100 instrument, supplied by Fischer Technology, Inc., and was reported as Martens Hardness (HM 0.3/15/0), in the units of Newtons (N)/mm². As required in said standard test method, the following test parameters were specified: Maximum Total Load applied to sample was 0.3 Newtons (N), time period over which Maximum Total Load was applied to sample was 15 seconds, and the time of duration for which said Maximum Total Load was then applied to sample was 0 seconds. Therefore, the test results were designated with the term “HM 0.3/15/0” in order to reflect these three test parameters.

Heat Distortion Temperature (i.e., temperature at which deflection of 0.254 mm (10 mils) of the sample bar occurs) and Total Deflection Temperature (i.e., temperature at which deflection of 2.54 mm (100 mils) of the sample bar occurs), were measured in accordance with ASTM D648 Method B, using an EDT Vicat instrument, supplied by CEAST USA, Inc.

Impact testing was accomplished in accordance with the Impact Energy Test, as described herein, and the results are reported in energy units (Joules). The Impact Energy Test consists of testing a flat sheet sample of polymerizate having a thickness of 3 mm, and cut into a square piece approximately 4 cm×4 cm. Said flat sheet sample of polymerizate is supported on a flat O-ring which is attached to top of the pedestal of a steel holder, as defined below. Said O-ring is constructed of neoprene having a hardness of 40±5 Shore A durometer, a minimum tensile strength of 8.3 MPa, and a minimum ultimate elongation of 400 percent, and has an inner diameter of 25 mm, an outer diameter of 31 mm, and a thickness of 2.3 mm. Said steel holder consists of a steel base, with a mass of approximately 12 kg, and a steel pedestal affixed to said steel base. The shape of said steel pedestal is approximated by the solid shape which would result from adjoining onto the top of a cylinder, having an outer diameter of 75 mm and a height of 10 mm, the frustum of a right circular cone, having a bottom diameter of 75 mm, a top diameter of 25 mm, and a height of 8 mm, wherein the center of said frustum coincides with the center of said cylinder. The bottom of said steel pedestal is affixed to said steel base, and the neoprene O-ring is centered and affixed to the top of the steel pedestal. The flat sheet sample of polymerizate is centered and set on top of the O-ring. The Impact Energy Test is carried out by dropping steel balls of increasing weight from a distance of 50 inches (1.27 meters) onto the center of the flat sheet sample. The sheet is determined to have passed the test if the sheet does not fracture. The sheet is determined to have failed the test when the sheet fractures. As used herein, the term “fracture” refers to a crack through the entire thickness of the sheet into two or more separate pieces, or detachment of one or more pieces of material from the backside of the sheet (i.e., the side of the sheet opposite the side of impact), The impact strength of the sheet is reported as the impact energy that corresponds to the highest level (i.e., largest ball) at which the sheet passes the test, and it is calculated according to the following formula:

E=mgd

Wherein E represent impact energy in Joules (J), m represents mass of the ball in kilograms (kg), g represents acceleration due to gravity (i.e., 9.80665 m/sec²) and d represents the distance of the ball drop in meters (i.e., 1.27 m).

The NCO concentration of the prepolymer (Component A) was determined by reaction with an excess of n dibutylamine (DBA) to form the corresponding urea followed by titration of the unreacted DBA with HCl in accordance with the following procedure.

Reagents
1. Tetrahydrofuran (THF), reagent grade.
2. 80/20 THF/propylene glycol (PG) mix.
   This solution was prepared in-lab by mixing 800 mls PG with 3.2 liters of THF in a 4-liter bottle.
3. DBA, dibutylamine certified ACS.
4. DBA/THF solution. 150 mL of DBA was combined with 750 mL of THF; it was mixed well and transferred to an amber bottle.
5. Hydrochloric acid, concentrated. ACS certified.
6. Isopropanol, technical grade.
7. Alcoholic hydrochloric acid, 0.2N. 75 ml of conc. HCl was slowly added to a 4-liter bottle of technical grade isopropanol while stirring with a magnetic stirrer; it was mixed for a minimum of 30 minutes. This solution was standardized using THAM (Tris hydroxyl methyl amino methane) as follows: Into a glass 100-mL beaker, was weighed approximately 0.6 g (HOCH₂)₃CNH₂ primary standard to the nearest 0.1 mg and the weight was recorded. 100 mL DI water was added and mixed to dissolve and titrated with the prepared alcoholic HCl.
   This procedure was repeated a minimum of one time and the values were averaged using the calculation below.

$$Normality HCL = \frac{( Standard wt . , grams )}{( mL s HCl ) ( 0.12114 )}$$

Equipment
1. Polyethylene beakers, 200-mL, Falcon specimen beakers, No. 354020.
2. Polyethylene lids for above, Falcon No. 354017.
3. Magnetic stirrer and stirring bars.
4. Brinkmann dosimeter for dispensing or 10-mL pipet.
5. Autotitrator equipped with pH electrode.
6. 25-mL, 50-mL dispensers for solvents or 25-mL and 50-mL pipets.

Procedure
1. Blank determination: Into a 220-mL polyethylene beaker was added 50 mL THF followed by 10.0 mL DBA/THF solution. The solution was capped and mixed with magnetic stirring for 5 minutes. 50 mL of the 80/20 THF/PG mix was added and titrated using the standardized alcoholic HCl solution and this volume was recorded. This procedure was repeated and these values averaged for use as the blank value.
2. In a polyethylene beaker was weighed 1.0 gram of prepolymer sample and the weight was recorded to the nearest 0.1 mg. 50 mL THF was added, the sample was capped and allowed to dissolve with magnetic stirring.
3. 10.0 mL DBA/THF solution was added, the sample was capped and allowed to react with stirring for 15 minutes.
4. 50 mL of 80/20 THF/PG solution was added.
5. The beaker was placed on the titrator and the titration was started. This procedure was repeated.

Calculations

$$\% N C O = \frac{\begin{matrix}( ml s Blank - ml s Sample ) \times \\ ( Normality HCl ) \times ( 4.2018 )\end{matrix}}{Sample weight , g}$$

$$I E W = \frac{( Sample wt . , grams ) \times ( 1000 )}{\begin{matrix}( ml s Blank - ml s Sample ) \times \\ ( Normality HCl )\end{matrix}}$$

$$I E W = Isocyanate Equivalent Weight$$

The SH groups within the product were determined using the following procedure. A sample size (0.1 mg) of the product was combined with 50 mL of tetrahydrofuran (THF)/propylene glycol (80/20) and stirred at room temperature until the sample was substantially dissolved. While stirring, 25.0 mL of 0.1 N iodine solution (which was commercially obtained from Aldrich 31, 8898-1) was added to the mixture and then allowed to react for a time period of from 5 to 10 minutes. To this mixture was added 2.0 mL concentrated HCl. The mixture was then titrated potentiometrically with 0.1 N sodium thiosulfate in the millivolt (mV) mode. A blank value was initially obtained by titrating 25.0 mL iodine (including 1 mL of concentrated hydrochloric acid) with sodium thiosulfate in the same manner as conducted with the product sample.

$$\% S H = \frac{\begin{matrix}( ml s Blank - ml s Sample ) \times \\ ( Normality {NA}_{2} {S}_{2} {O}_{3} ) \times ( 3.307 )\end{matrix}}{Sample weight , g}$$

### Example 1

### Synthesis of Polyurethane Prepolymer 1

4,4′-methylenebis (cyclohexyl isocyanate) (Desmodur W) (1.0 molar equivalent) was charged into a reactor with N₂ pad and heated to a temperature of 70° C. Then, 1,1,1 tris(hydroxymethyl) propane (TMP) (0.2 molar equivalent) was added to the reactor. When introduced into the reactor, the TMP dissolved slowly. During the slow dissolution the reaction underwent a short induction period prior to exhibiting a significant exotherm in temperature (approximately, Δ=50° C.). Care was taken to minimize the extent of the exotherm by keeping the reaction temperature below 120° C., which was achieved by adding the TMP to the reactor in portions. Once all of the TMP was added, the resultant reaction mixture was heated for 20 hours in the reactor at a temperature within the range of from 110-120° C. This reaction mixture represented Component A.

Prepolymer 1 had % NCO of 23.74% and viscosity of 90 cP at 73° C.

Prepolymer 2 and Prepolymer 3 were synthesized according to the same procedure as Prepolymer 1, with the stoichiometry given in Table 1.

TABLE 1
Polyurethane Prepolymer Preparation

| | TMP¹ | | | |
|---|---|---|---|---|
| Prepolymer | (Molar | Des W² | NCO | Viscosity |
| (Component A) | Equiv) | (Molar Equiv) | (%) | 73° C. (cP) |
| Prepolymer 1 | 0.20 | 1.00 | 23.74 | 90 |
| Prepolymer 2 | 0.28 | 1.00 | 20.75 | 2103 |
| Prepolymer 3 | 0.30 | 1.00 | 20.63 | 7000 |

¹TMP - 1,1,1-Tris(hydroxymethyl)propane, obtained from Aldrich, USA
²Des W - 4,4′-Methylenebis(cyclohexyl isocyanate), Bayer Corporation

TABLE 2
Selected Properties of Chain Extended
Polyurethane/Sulfur-containing Polyurethane Polymers

| | | Compo- | | | |
|---|---|---|---|---|---|
| Polymer | | nent B | Refractive | | |
| (Components | Component | (Molar | Index | Impact** | Haze* |
| A + B) | A | Equiv.) | Abbe | (J) | (%) |
| Polymer 1 | Prepolymer | BDO | 1.523, 50 | 13.3 J | 2.16 |
| | 3 | (1.0) | | | |
| Polymer 2 | Prepolymer | DMDS | 1.570, 44 | 2.47 J | 1.39 |
| | 2 | (1.0) | | | |
| Polymer 3 | Prepolymer | DMDS | 1.570, 43 | 13.3 J | 0.38 |
| | 1 | (1.0) | | | |

Description of the abbreviations in Table 2:
BDO - 1,4-Butanediol, obtained from Aldrich, USA
DMDS - 2-Mercaptoethyl sulfide, obtained from Nisso-Maruzen Chemical Company, Japan

### Example 2

### Chain Extension of Polyurethane Prepolymer 3 with 1,4-butanediol (Polymer 1)

Prepolymer 3 (1.0 eq.) and 1,4-BDO (1.0 eq.) were mixed together using two component reaction injection molding equipment. The temperature of the two components when mixed was 25° C. for 1,4-BDO and 80° C. for Prepolymer 3. The resultant reaction mixture was then introduced into a 3 mm thick flat sheet and ophthalmic lens mold set-up(s). The flat sheet and lens mold set-ups were then placed in a convection oven and heated. The materials were heated at a temperature of 110° C. for 76 hours. After the heating period, the temperature of the oven was reduced to 80° C. over a 30-minute time interval. The materials were then removed from the oven and demolded. The resultant polymerizate, Polymer 1, had the following properties: refractive index (nₑ²⁰) 1.523, Abbe Number 50, Impact strength 13.3 Joules, Haze 2.16%, Martens Microhardness (HM 0.3/15/0) 135 N/mm², Heat Distortion Temperature 113 DC; Total Deflection Temperature 121° C.

### Example 3

### Chain Extension of Polyurethane Prepolymer 2 with DMDS (Polymer 2)

Prepolymer 2 (1.0 eq.) was mixed together with DMDS (1.0 eq.) using two component reaction injection molding equipment. The temperature of the two components when mixed was 25° C. for DMDS and 70° C. for Prepolymer 2. The resultant reaction mixture was then introduced into a 3 mm thick flat sheet and ophthalmic lens mold set-up. The flat sheet and lens mold set-ups were then placed in a convection oven and heated. The materials were heated at a temperature of 110° C. for 76 hours. After the heating period, the temperature of the oven was reduced to 80° C. over a 30-minute time interval. The materials were then removed from the oven and demolded. The resultant polymerizate, Polymer 2, had the following properties: refractive index (nₑ²⁰) 1.570, Abbe Number 44, Impact strength 2.47 Joules, Haze 1.39%, Martens Microhardness (HM 0.3/15/0) 132 N/mm², Heat Distortion Temperature 101 DC; Total Deflection Temperature 105° C.

### Example 4

### Chain Extension of Polyurethane Prepolymer 1 with DMDS (Polymer 3)

Prepolymer 1 (1.0 eq.) was mixed together with DMDS (1.0 eq.) using two component reaction injection molding equipment. The temperature of the two components when mixed was 25° C. for DMDS and 70° C. for Prepolymer 1. The resultant reaction mixture was then introduced into a 3 mm thick flat sheet and ophthalmic lens mold set-up. The flat sheet and lens mold set-ups were then placed in a convection oven and heated. The materials were heated at a temperature of 110° C. for 76 hours. After the heating period, the temperature of the oven was reduced to 80° C. over a 30-minute time interval. The materials were then removed from the oven and demolded. The resultant polymerizate, Polymer 3, had the following properties: refractive index (nₑ²⁰) 1.570, Abbe Number 43, Impact strength 13.3 Joules, Haze 0.38%, Martens Microhardness (HM 0.3/15/0) 118 N/mm², Heat Distortion Temperature 95° C.; Total Deflection Temperature 106° C.

The following provides the ball sizes used in the Impact Energy test for this example, and the corresponding impact energy.

| Ball weight, kg | Impact Energy, J |
|---|---|
| 0.016 | 0.20 |
| 0.022 | 0.27 |
| 0.032 | 0.40 |
| 0.045 | 0.56 |
| 0.054 | 0.68 |
| 0.067 | 0.83 |
| 0.080 | 1.00 |
| 0.094 | 1.17 |
| 0.110 | 1.37 |
| 0.129 | 1.60 |
| 0.149 | 1.85 |
| 0.171 | 2.13 |
| 0.198 | 2.47 |
| 0.223 | 2.77 |
| 0.255 | 3.17 |
| 0.286 | 3.56 |
| 0.321 | 3.99 |
| 0.358 | 4.46 |
| 0.398 | 4.95 |
| 1.066 | 13.30 |

We claim:

1. Sulfur-containing polyurethane comprising the reaction product of:
(a) material chosen from polyisocyanate, polyisothiocyanate or mixtures thereof;
(b) material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, and mixtures thereof; and
(c) material chosen from diol having molecular weight of less than or equal to 200 grams/mole, dithiol having molecular weight of less than or equal to 600 grams/mole, difunctional material containing both hydroxyl and SH groups having molecular weight of less than or equal to 600 grams/mole, and mixtures thereof, wherein at least one of (a), (b) or (c) is sulfur-containing.

2. The sulfur-containing polyurethane of claim 1 wherein said dithiol in (c) comprises dithiol oligomer having number average molecular weight of less than or equal to 600 grams/mole, with the proviso that said dithiol oligomer constitutes less than or equal to 70 mole percent of (c) reactant.

3. The sulfur-containing polyurethane of claim 1 prepared by reacting (a) and (b) to form polyurethane prepolymer and chain-extending said prepolymer with (c).

4. The sulfur-containing polyurethane of claim 1 wherein (a), (b), and (c) are reacted in a one-pot process.

5. The polyurethane of claim 1 wherein said polyisocyanate is chosen from aliphatic polyisocyanates, cycloaliphatic polyisocyanates, aromatic polyisocyanates, and mixtures thereof.

6. The polyurethane of claim 5 wherein said polyisocyanate is chosen from 1,3-bis(1-isocyanato-1-methylethyl)benzene; 3-isocyanato-methyl-3,5,5,-trimethyl cyclohexyl isocyanate; 4,4-methylene bis(cyclohexyl isocyanate); meta-xylylene diisocyanate; and mixtures thereof.

7. The sulfur-containing polyurethane of claim 3 wherein said polyurethane prepolymer is sulfur-containing.

8. The sulfur-containing polyurethane of claim 7 wherein said sulfur-containing polyurethane prepolymer comprises the reaction product of:
(a) at least one of polyisothiocyanate or mixture of polyisothiocyanate and polyisocyanate; and
(b) at least one of trifunctional or higher-functional polyol, trifunctional or higher-functional polythiol, or mixture thereof.

9. The sulfur-containing polyurethane of claim 7 wherein said sulfur-containing polyurethaneprepolymer comprises the reaction product of:
(a) at least one of polyisocyanate, polyisothiocyanate or mixture thereof: and
(b) at least one of trifunctional or higher-functional polythiol, or mixture of trifunctional or higher-functional polythiol and trifunctional or higher-functional polyol.

10. The sulfur-containing polyurethane of claim 1 wherein said diol is chosen from 1,2-butanediol; 1,4-butanediol; 1,3-butanediol; 1,5-pentanediol; 2,4-pentanediol; 1,6 hexanediol; 2,5-hexanediol; 2,4-heptanediol; 2-ethyl-1,3-hexanediol; 2,2-dimethyl-1,3-propanediol; 1,4-cyclohexanedimethanol; ethylene glycol; propylene glycol; diethylene glycol; dipropylene glycol; and mixtures thereof.

11. The sulfur-containing polyurethane of claim 1 wherein said trifunctional or higher-functional polyol is chosen from, trimethylolethane, trimethylolpropane, and mixtures thereof.

12. The sulfur-containing polyurethane of claim 1 wherein said polyurethane is adapted to an optical article having a refractive index of at least 1.55 and an Abbe number of at least 30.

13. The sulfur-containing polyurethane of claim 1 wherein said polyurethane is adapted to an optical article having a refractive index of at least 1.57 and an Abbe number of at least 30.

14. The sulfur-containing polyurethane of claim 1 wherein the ratio of the sum of the number of equivalents in (b) to the sum of the number of equivalents in (a) is from 0.05:1.0 to 0.4:1.0.

15. A sulfur-containing polyurethane comprising the reaction product of:
(a) at least one of polyisocyanate, polyisothiocyanate or mixture thereof;
(b) trifunctional or higher-functional polythiol having molecular weight of less than or equal to 700 grams/mole; and
(c) dithiol having molecular weight of less than or equal to 600 grams/mole, wherein said dithiol comprises dithiol oligomer having number average molecular weight of less than or equal to 600 grams/mole, with the proviso that said dithiol oligomer constitutes less than or equal to 70 mole percent of (c) reactant.

16. The sulfur-containing polyurethane of claim 15 wherein said trifunctional or higher-functional polythiol is chosen from trifunctional polythiol, tetrafunctional polythiol, and mixtures thereof.

17. A sulfur containing polyurethane comprising the reaction product of:
(a) at least one of polyisocyanate, polyisothiocyanate or mixture thereof;
(b) trifunctional or higher-functional polyol having molecular weight of less than or equal to 200 grams/mole; and
(c) dithiol having molecular weight of less than or equal to 600 grams/mole, wherein said dithiol comprises dithiol oligomer having number average molecular weight of less than or equal to 600 grams/mole, with the proviso that said dithiol oligomer constitutes less than or equal to 70 mole percent of (c) reactant.

18. The sulfur-containing polyurethane of claim 15 wherein (c) further comprises at least one of trifunctional or higher-functional polyol, trifunctional or higher-functional polythiol, or mixtures thereof.

19. The sulfur-containing polyurethane of claim 17 wherein (c) further comprises at least one of trifunctional or higher-functional polyol, trifunctional or higher functional polythiol, or mixtures thereof.

20. A sulfur-containing polyurethane comprising reaction product of:
(a) at least one material chosen from polyisocyanate, polyisothiocyanate or mixtures thereof;
(b) at least one material chosen from trifunctional or higher-functional polyol, trifunctional or higher-functional material containing both hydroxyl and SH groups, trifunctional or higher-functional polythiol, or mixtures thereof; and
(c) at least one material chosen from diol, dithiol, difunctional material containing both hydroxyl and SH groups, or mixtures thereof,
wherein at least one of (a), (b) or (c) is sulfur-containing; and wherein the ratio of the sum of the number of equivalents of (b) to the sum of the number of equivalents in (a) is from 0.05:1.0 to 0.4:1.0.

21. A sulfur-containing polyurethane of claim 20 wherein said dithiol in (c) comprises dithiol oligomer having number average molecular weight less than or equal to 600 grams/mole, with the proviso that said dithiol oligomer constitutes less than or equal to 70 mole percent of (c) reactant.

22. A method of preparing sulfur-containing polyurethane comprising:
(a) reacting at least one of polyisocyanate, or polyisothiocyanate or mixture thereof with at least one of trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, or mixtures thereof; to form polyurethane prepolymer, and
(b) reacting said prepolymer with at least one active hydrogen-containing material chosen from diol having molecular weight of less than or equal to 200 grams/mole, dithiol having molecular weight of less than or equal to 600 grams/mole, difunctional material containing both hydroxyl and SH groups having molecular weight of less than or equal to 600 grams/mole, or mixtures thereof,
wherein at least one of (a) or (b) is sulfur-containing.

23. The method of claim 22 wherein said dithiol in (b) comprises dithiol oligomer having number average molecular weight of less than or equal to 600 grams/mole, with the proviso that said dithiol oligomer constitutes less than or equal to 70 mole percent of active hydrogen-containing in (b).

24. A method of preparing sulfur-containing polyurethane comprising reacting
(a) at least one material chosen from polyisocyanate, polyisothiocyanate or mixtures thereof;
(b) at least one material chosen from trifunctional or higher-functional polyol having molecular weight of less than or equal to 200 grams/mole, trifunctional or higher-functional polythiol having molecular weight of less than or equal to 700 grams/mole, trifunctional or higher-functional material containing both hydroxyl and SH groups having molecular weight of less than or equal to 700 grams/mole, or mixtures thereof; and
(c) at least one material chosen from diol having molecular weight of less than or equal to 200 grams/mole, dithiol having molecular weight less of than or equal to 600 grams/mole, difunctional material containing both hydroxyl and SH groups having molecular weight of less than or equal to 600 grams/mole, or mixtures thereof,
in a one-pot process, wherein at least one of (a), (b) or (c) is sulfur-containing.

25. The method of claim 24 wherein said dithiol of (c) comprises dithiol oligomer having number average molecular weight of less than or equal to 600 grams/mole, with the proviso that said dithiol oligomer constitutes less than or equal to 70 mole percent of (c) reactant.
